(19) United States
(12) Patent Application Publication
(10) Pub. No.: US 2004/0173775 A1
(43) Pub. Date: Sep. 9, 2004

(54) Fluid crystalline medium and high-torsion liquid crystalline display device

(76) Inventors: Juliane Suermann, Darmstadt (DE); Andreas Taugerbeck, Darmstadt (DE); Peer Kirsch, Darmstadt (DE); Detlef Pauluth, Ober-Ramstadt (DE)

Correspondence Address: Millen White, Zelano & Branigan, Arlington Courthouse Plaza I, 2200 Clarendon Boulevard Suite 1400, Arlington, VA, 22201, US

(21) Appl. No.: 10/480,788

(22) PCT Filed: May 16, 2002
(86) PCT No.: PCT/EP02/05388

(30) Foreign Application Priority Data
Jun. 13, 2001 (DE) 101 28 773.9

(51) Int. Cl. C09K 19/30; C09K 19/12; C09K 19/20

(52) U.S. Cl. 252/299.63; 252/299.66; 252/299.67; 428/1.1

(57) ABSTRACT

The invention relates to a high-torsion liquid crystalline medium, the use thereof for electro-optical purposes, and display devices containing said medium.

The present invention relates to a high-twist liquid-crystalline medium, to the use thereof for electro-optical purposes and to displays containing this medium.

Liquid-crystal displays are known from the prior art. The most common display devices are based on the Schadt-Helfrich effect and contain a liquid-crystal medium having a twisted nematic structure, such as TN (twisted nematic) cells having typical twist angles of 90° and STN (super-twisted nematic) cells having typical twist angles of from 180 to 270°. Furthermore, ferroelectric liquid-crystal displays are known which contain a liquid-crystal medium having a twisted smectic structure. In these displays, the twisted structure is usually achieved by adding one or more chiral dopants to a nematic or smectic liquid-crystal medium.

In addition, liquid-crystal displays are known which contain liquid-crystal (LC) media having a chiral nematic or cholesteric structure. These media have a considerably higher twist than the media from TN and STN cells.

Cholesteric liquid crystals exhibit selective reflection of circularly polarized light, the direction of rotation of the light vector corresponding to the handedness of the cholesteric helix. The reflexion wavelength λ can be calculated from the pitch p of the cholesteric helix and the average birefringence n of the cholesteric liquid crystal in accordance with equation (1):

λ=n·p (1)

The terms “chiral nematic” and “cholesteric” are used simultaneously in the prior art. “Chiral nematic” often refers to LC materials consisting of a nematic host mixture doped with an optically active component which induces a helically twisted superstructure. In contrast, “cholesteric” often refers to chiral LC materials, for example cholesteryl derivatives, which have a “natural” helically twisted cholesteric phase. Both terms are also used in parallel to mean the same thing. In the present application, both of the abovementioned types of LC materials are referred to as “cholesteric”, and this term is meant to encompass the broadest meaning of “chiral nematic” and “cholesteric”.

The most common cholesteric liquid-crystal (CLC) displays are SSCT (surface stabilized cholesteric texture) and PSCT (polymer stabilized cholesteric texture) displays.

SSCT and PSCT displays usually contain a CLC medium which, for example, exhibits in the initial state a planar structure reflecting light of a particular wavelength and can be switched to a focal conic, light-scattering structure by applying an electric alternating current pulse, or vice versa.

These displays are bistable, i.e. the respective state is retained after the electrical field is switched off and is transferred back into the initial state only by re-applying a field. A pixel can therefore be generated by a short voltage pulse, in contrast to, for example, electro-optical TN or STN displays in which the LC medium in an addressed pixel immediately returns to the initial state after the electric field is switched off, so that it is necessary to maintain the addressing voltage to generate a permanent pixel.

When a higher voltage pulse is applied, the CLC medium is transferred into a homeotropic, transparent state from which it relaxes into the planar state when the voltage is switched off quickly, or into the focal conic state when the voltage is switched off slowly.

In SSCT displays, the planar alignment of the CLC medium in CLC cells in the initial state is achieved, for example, by surface treatment of the cell walls. In PSCT displays, the CLC medium additionally comprises a phase-separated polymer or polymer network which stabilizes the structure of the CLC medium in the respective addressed state.

For instance, WO 92/19695 and U.S. Pat. No. 5,384,067 describe a PSCT display containing a CLC material having positive dielectric anisotropy and up to 10% by weight of a phase-separated polymer network dispersed in the liquid-crystal material. For instance, U.S. Pat. No. 5,453,863 describes an SSCT display containing a polymer-free CLC material having positive dielectric an isotropy.

CLC displays generally require no backlighting. In the planar state, the CLC medium in a pixel exhibits selective reflection of light of a particular wavelength in accordance with equation (1) above, so that the pixel appears in the corresponding reflection colour, for example on a black background. The reflection colour disappears upon transition to the focal conic, scattering or homoeotropic, transparent state.

For the above reasons, CLC displays consume considerably less power than TN or STN displays. Moreover, they exhibit a low viewing-angle dependence, if any, in the scattering state. In addition, they do not require active-matrix addressing like TN displays, but can be operated in the simpler multiplex or passive-matrix mode.

A CLC medium for the abovementioned displays can be prepared, for example, by doping a nematic LC mixture with a highly-twisting chiral dopant. The pitch p of the cholesteric helix induced can then be calculated from the concentration c and the helical twisting power HTP of the chiral dopant in accordance with equation (2):

p=(HTP·c)⁻¹ (2)

Alternatively, two or more dopants can be used, for example to compensate for the temperature dependence of the HTP of the individual dopants and thus to achieve a lower temperature dependence of the helical pitch and the reflection wavelength of the CLC medium.

For use in the abovementioned CLC displays, the chiral dopants should exhibit a very high twisting power with low temperature dependence, a high stability and a good solubility in the liquid-crystalline host phase. Moreover they should ideally not have an adverse effect on the liquid-crystalline and electro-optical properties of the liquid-crystalline host phase. A high twisting power of the dopants is desired, inter alia, to achieve small pitches, e.g. in cholesteric displays, but also to be able to lower the concentration of the dopant. As a result, on the one hand the risk of impairment of the properties of the liquid-crystal medium by the dopant is lowered, and on the other hand the scope with regard to the solubility of the dopant is extended, so that it is possible, for example, to use dopants of relatively low solubility.

For use in the abovementioned CLC displays, the liquid-crystal media must have a good chemical and thermal stability and a good stability towards electric fields and electromagnetic radiation. Furthermore, the liquid-crystal materials should have a broad cholesteric liquid-crystal phase exhibiting a high clearing point, a sufficiently high birefringence, a high positive dielectric anisotropy and a low rotational viscosity.

The CLC materials should furthermore be such that different reflection wavelengths, in particular in the visible range, can be realized by simple and controlled variation. They should furthermore exhibit a low temperature dependence of the reflection wavelength.

Since liquid crystals are generally used as mixtures of a plurality of compontents, it is important that the components are readily miscible with one another. Further properties, such as the dielectric aniosotropy and the optical anisotropy, must satisfy different requirements depending on the cell type.

However, favourable values for all abovementioned parameters cannot be achieved using the media available from the prior art.

For example, EP 0 450 025 describes a cholesteric liquid-crystal mixture consisting of a nematic liquid-crystal comprising two or more chiral dopants. However, the mixtures disclosed therein have only a low birefringence and low clearing points. Moreover, they have a high proportion of 26% of chiral dopants.

There is thus a great demand for LC media for CLC displays which have a high twist, a broad operating temperature range, short response times, a low threshold voltage and a low temperature dependence of the reflection wavelength and which do not have the disadvantages of the media of the prior art, or at least do so to a significantly reduced extent.

It is an object of the invention to provide media for CLC displays which have the abovementioned required properties and which do not have the disadvantages of the media of the prior art, or at least do so to a significantly reduced extent.

It has now been found that this object can be achieved by using media according to the invention in CLC displays.

The invention thus relates to a liquid-crystalline medium having a helically twisted structure and comprising a nematic component and an optically active component, characterized in that

the optically active component comprises one or more chiral compounds whose twisting power and concentration are selected such that the helical pitch of the medium is ≦1 μm, and

the nematic component comprises one or more compounds of the formula I

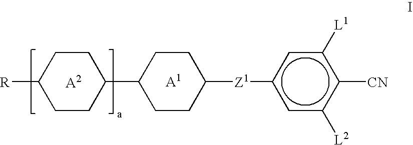

and one or more compounds selected from the formulae 11 and IlIl

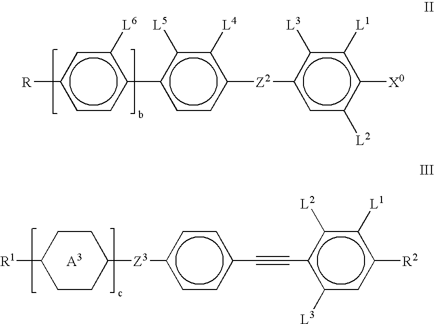

in which

R, R¹ and R² are each, independently of one another, H, an alkyl or alkenyl radical having 1 to 15 carbon atoms which is unsubstituted, monosubstituted by CN or CF₃ or at least monosubstituted by halogen, where one or more CH₂ groups in these radicals may also, in each case independently of one another, be replaced by

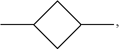

—O—, —S—, —CO—, —CO—O—, —O—CO—, —O—CO—O— or —C≡C— in such a way that oxygen atoms are not linked directly to one another,

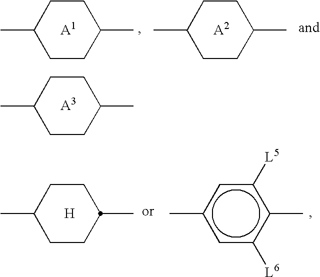

and are each, independently of one another,

L¹ to L⁶ are each, independently of one another H or F,

Z¹ is —COO— and, if at least one of the radicals A¹ and A² is trans-1,4-cyclohexylene, furthermore —CH₂CH₂— or a single bond,

Z² is —CH₂CH₂— or a single bond,

Z³ is —COO—, —CH₂CH₂— or a single bond,

X⁰ is F, Cl, CN, halogenated alkyl, alkenyl or alkoxy having 1 to 6 carbon atoms, and

a, b and c are each, independently of one another, 0 or 1.

The use of the compounds of the formulae I, II and III in the mixtures for CLC displays according to the invention results in a high polarity, i.e. low threshold voltages, and a high Δn value, i.e. high transmission in the switched state.

In particular, the compounds of the formula I reduce the threshold voltage.

In particular, the compounds of the formulae II and III increase the birefringence and thus the contrast.

Furthermore, the mixtures according to the invention have the following advantages:

they have a broad cholesteric phase range, in particular at low temperatures, and a high clearing point,

they have a high UV stability.

The compounds of the formulae I, II and III have a broad range of application. Depending on the choice of substituents, these compounds can serve as base materials of which liquid-crystalline media are predominantly composed; however, it is also possible to add compounds of the formulae I, II and III to liquid-crystalline base materials from other classes of compounds in order, for example, to modify the dielectric and/or optical anisotropy of a dielectric of this type and/or to optimize its threshold voltage and/or its viscosity. In the pure state, the compounds of the formulae I, II and III are colourless and form liquid-crystalline mesophases in a temperature range which is favourably located for electro-optical use. They are stable chemically, thermally and to light.

Particular preference is given to compounds of the formula I in which at least one of the radicals A¹ and A² is trans-1,4-cyclohexylene and/or Z¹ is —COO—.

The compounds of the formula I are preferably selected from the following formulae

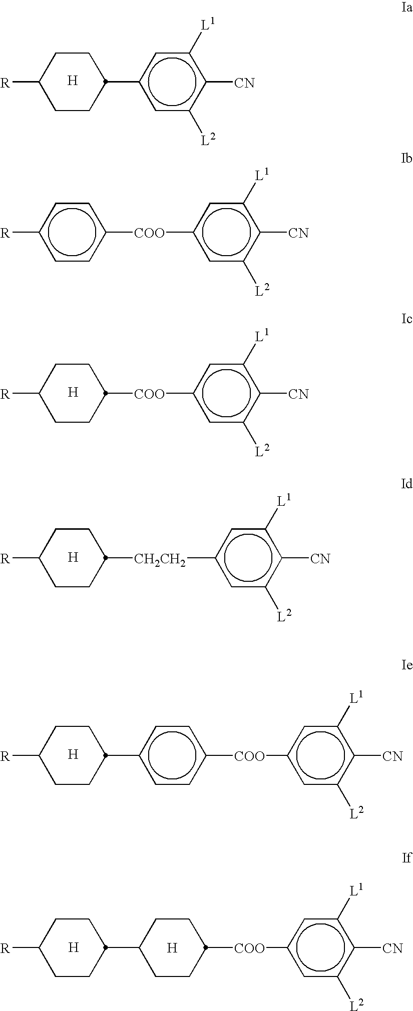

in which R is as defined in formula I and L¹ and L² are each, independently of one another, H or F. In these compounds, R is particularly preferably alkyl or alkoxy having 1 to 8 carbon atoms.

Particular preference is given to mixtures comprising one or more compounds of the formulae Ia, Ib or Ie, in particular those in which L¹ and/or L² are F.

Preference is furthermore given to mixtures comprising one or more compounds of the formula If in which L² is H and L¹ is H or F, in particular F.

The compounds of the formula II are preferably selected from the following formulae

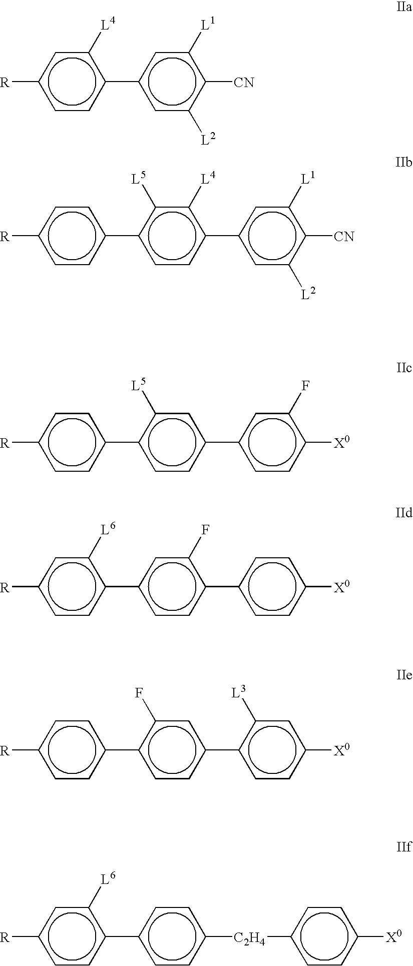

in which R is as defined in formula I, X⁰ is F or Cl and L¹ to L⁶ are each, independently of one another, H or F. In these compounds, R is particularly preferably alkyl or alkoxy having 1 to 8 carbon atoms.

Particular preference is given to compounds of the formulae IIa and IIb, in particular those in which L¹, L² and L⁴ are H. Preference is furthermore given to compounds of the formulae IIc and IId in which X⁰ is Cl, compounds of the formulae IId and IIf in which L⁶ is F and compounds of the formulae IIe and IIf in which L³ or L⁶ is F and X⁰ is preferably F.

The compounds of the formula III are preferably selected from the following formulae

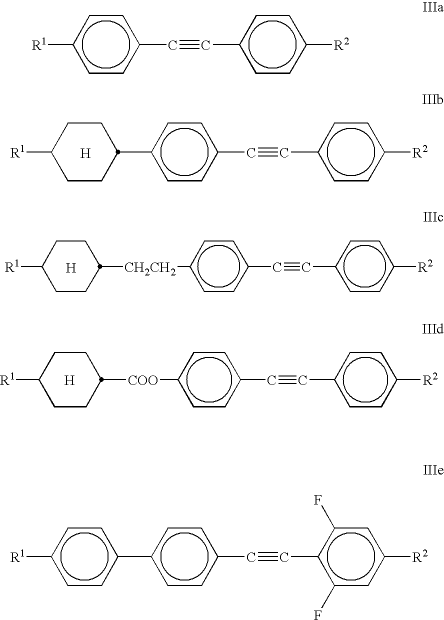

in which R¹ and R² are as defined above. In these compounds, R¹ and R² are particularly preferably alkyl or alkoxy having 1 to 8 carbon atoms.

Particular preference is given to compounds of the formulae IIIa, IIIb and IIIe.

Preferred liquid-crystal mixtures preferably comprise, in addition to the compounds of the formulae I, II and III, one or more compounds selected from the group consisting of the bicyclic compounds of the following formulae

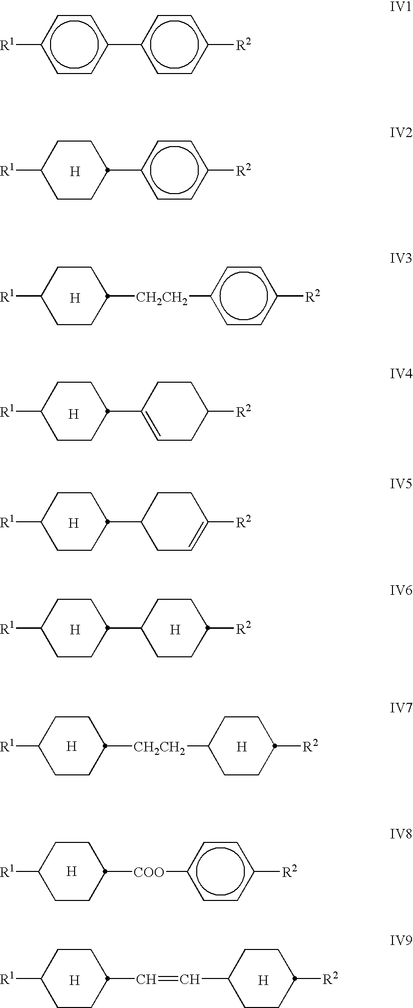

and/or one or more compounds selected from the group consisting of the tricyclic compounds of the following formulae

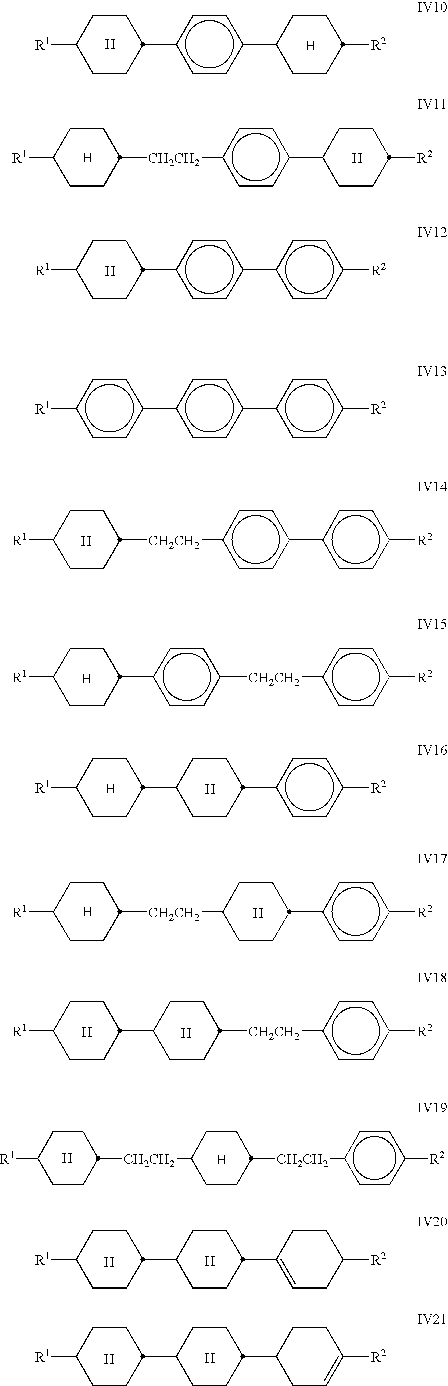

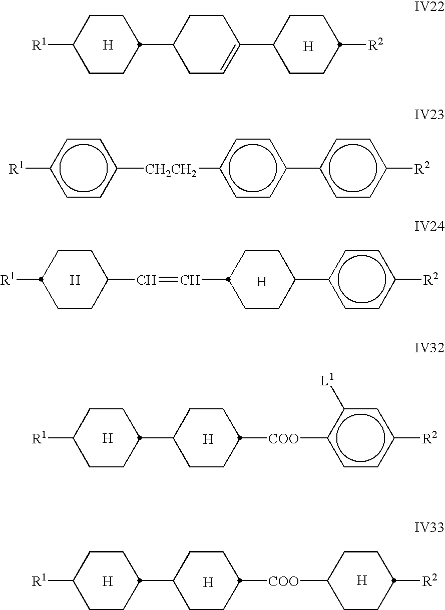

and/or one or more compounds selected from the group consisting of the tetracyclic compounds of the following formulae

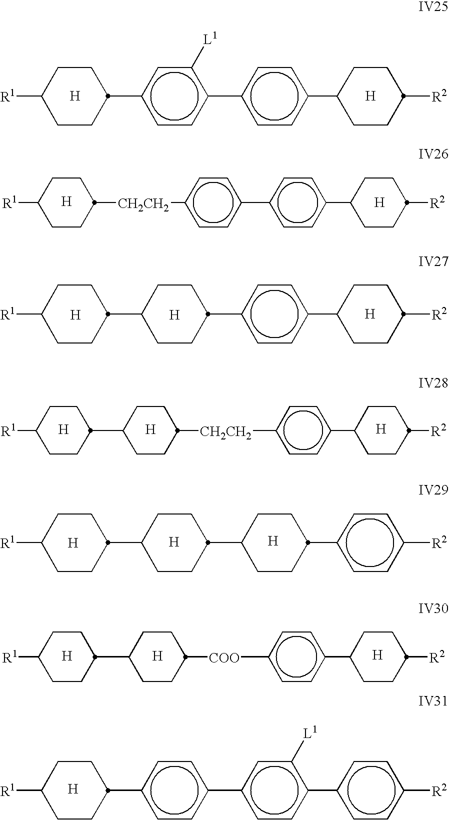

in which R¹ and R² are as defined in formula II and are preferably each, independently of one another, an alkyl, alkoxy or alkenyl group having 1 to 12 carbon atoms, where one or two non-adjacent CH₂ groups may also be replaced by —O—, —CH═CH—, —C≡C—, —CO—, —OCO— or —COO— in such a way that oxygen atoms are not linked directly to one another, and L¹ is H or F.

The 1,4-phenylene groups in IV10 to IV19 and IV23 to IV 32 may also each, independently of one another, be monosubstituted or polysubstituted by fluorine.

Particular preference is given to compounds of the formulae IV 25 to IV 31 in which R¹ is alkyl and R² is alkyl or alkoxy, in particular alokxy, in each case having 1 to 7 carbon atoms. Preference is furthermore given to compounds of the formulae IV 25 and IV 31 in wich L¹ is F. Very particular preference is given to compounds of the formulae IV25 and IV27.

In the compounds of the formulae IV1 to IV30, R¹ and R² are particularly preferably straight-chain alkyl or alkoxy having 1 to 12 carbon atoms.

The mixtures according to the invention preferably comprise, in addition to the compounds of the formulae I, II and III, one or more alkenyl compounds selected from the formulae V1 and V2

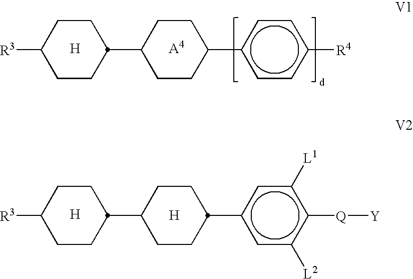

in which

A⁴ is 1,4-phenylene or trans-1,4-cyclohexylene,

d is 0 or 1,

R³ is an alkenyl group having 2 to 7 carbon atoms,

R⁴ is an alkyl, alkoxy or alkenyl group having 1 to 12 carbon atoms, where one or two non-adjacent CH₂ groups may also be replaced by —O—, —CH═CH—, —C≡C—, —CO—, —OCO— or —COO— in such a way that oxygen atoms are not linked directly to one another,

Q is CF₂, OCF₂, CFH, OCFH or a single bond,

Y is F or Cl, and

L¹ and L² are each, independently of one another, H or F.

Particular preference is given to compounds of the formula V1 in which d is 1. Further preferred compounds of the formula V1 are selected from the following formulae

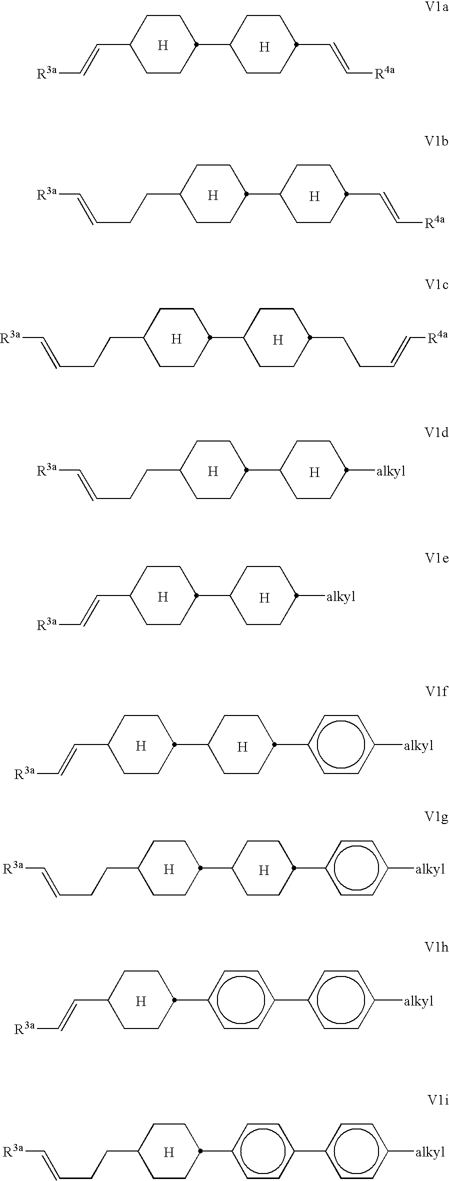

in which R^{3a} and R^{4a} are each, independently of one another, H, CH₃, C₂H₅ or n-C₃H₇ and alkyl is an alkyl group having 1 to 8 carbon atoms.

Particular preference is given to compounds of the formula V1a, in particular those in which R^{3a} and R^{4a} are CH₃, compounds of the formula V1e, in particular those in which R^{3a} is H, and compounds of the formulae V1f, V1g, V1h and V1i, in particular those in which R^{3a} is H or CH₃.

Particularly preferred compounds of the formula V2 are those in which L¹ and/or L² are F and Q-Y is F or OCF₃. Further preferred compounds of the formula V2 are those in which R³ is 1E-alkenyl or 3E-alkenyl having 2 to 7 carbon atoms, in particular 2, 3 or 4 carbon atoms. Further preferred compounds of the formula V2 are those of the formula V2a

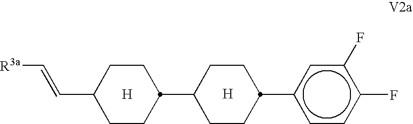

in which R^{3a} is H, CH₃, C₂H₅ or n-C₃H₇, in particular H or CH₃.

The use of compounds of the formula V1 and V2 leads to liquid-crystal mixtures according to the invention having particularly low rotational viscositiy values and to CLC displays having fast response times in particular at low temperatures.

In another preferred embodiment, the mixtures according to the invention preferably comprise, in addition to the compounds of the formulae I and II, one or more compounds of the formula VI1 and/or VI2

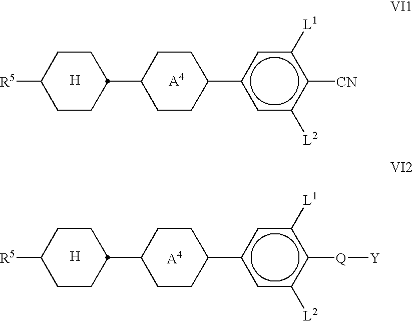

in which

A⁴ is 1,4-phenylene which may also be fluorinated in 3 and/or 5 position, or trans-1,4-cyclohexylene,

R⁵ is an alkyl, alkoxy or alkenyl group having 1 to 12 carbon atoms, where one or two non-adjacent CH₂ groups may also be replaced by —O—, —CH═CH—, —C≡C—, —CO—, —OCO— or —COO— in such a way that oxygen atoms are not linked directly to one another,

Q is CF₂, OCF₂, CFH, OCFH or a single bond,

Y is F or Cl, and

L¹ and L² are each, independently of one another, H or F.

Particular preference is given to compounds of the formulae VI1 and VI2 in which A⁴ is 1,4-phenylene.

Further preferred compounds of the formulae VI1 and VI2 are selected from the following formulae

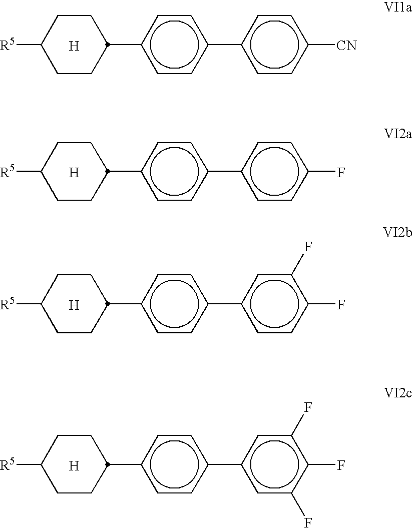

in which R⁵ is as defined above and is preferably alkyl or alkoxy having 1 to 8 carbon atoms.

Particular preference is given to compounds of the formulae VI1a and VI2b.

The compounds of the formulae VI1 and VI2 lead inter alia to an increase in birefringence in the media according to the invention. Especially the compounds of the formula VI2 increase the birefringence while maintaining a low viscosity.

The optically active component comprises one or more chiral dopants whose twisting power and concentration are selected such that the helical pitch of the LC medium is less than or equal to 1 μm.

The helical pitch of the medium is preferably from 130 nm to 1000 nm, in particular from 200 nm to 750 nm, particularly preferably from 300 nm to 450 nm.

The helical pitch is preferably chosen such that the medium reflects light in the visible wavelength range. The term “visible wavelength range” or “visible spectrum” typically comprises the range of wavelengths from 400 to 800 nm. Above and below, this term is also meant to encompass the wavelength range from 200 to 1200 nm including the UV and infrared (IR) range and the far UV and far IR range.

The reflection wavelength of the LC medium according to the invention is preferably in the range from 200 to 1500 nm, in particular from 300 to 1200 nm, particularly preferably from 350 to 900 nm, very particularly preferably from 400 to 800 nm. Preference is furthermore given to LC media having a reflection wavelength of from 400 to 700 nm, in particular from 400 to 600 nm.

The wavelength values given above and below refer to the half-width of the reflection band, unless indicated otherwise.

The ratio d/p between the layer thickness of the liquid crystal cell d (separation of the outer plates) in a CLC display according to the invention and the natural helical pitch p of the LC medium is preferably greater than 1, in particular in the range from 2 to 20, particularly preferably from 3 to 15, very particularly preferably from 4 to 10.

The proportion of the optically active component in the LC medium according to the invention is preferably ≦20%, in particular ≦10%, particularly preferably from 0.01 to 7%, very particularly preferably from 0.1 to 5%. The optically active component preferably comprises from 1 to 6, in particular 1, 2, 3 or 4, chiral compounds.

The chiral dopants should preferably have a high helical twisting power (HTP) with low temperature dependence. They should furthermore have a good solubility in the nematic component and not impair the liquid-crystalline properties of the LC medium, or impair them only to a small extent. They can have the same or the opposite orientation of rotation and the same or the opposite temperature dependence of the twist.

Particular preference is given to dopants having an HTP of 20 μm⁻¹ or more, in particular of 40 μm⁻¹ or more, particularly preferably of 70 μm⁻¹ or more.

For the optically active component, many chiral dopants, some of which are commercially available, are available to the person skilled in the art, such as cholesteryl nonanoate, R/S-811, R/S-1011, R/S-2011 or CB15 (Merck KGaA, Darmstadt).

Particularly suitable dopants are compounds which have one or more chiral radicals and one or more mesogenic groups, or one or more aromatic or alicyclic groups which form a mesogenic group with the chiral radical.

Suitable chiral radicals are for example chiral branched hydrocarbon radicals, chiral ethanediols, binaphthols or dioxolanes, furthermore monovalent or multivalent chiral radicals selected from the group comprising sugar derivatives, sugar alcohols, sugar acids, lactic acids, chiral substituted glycols, steroid derivatives, terpene derivatives, amino acids or sequences of a few, preferably 1-5, amino acids.

Preferred chiral radicals are sugar derivatives such as glucose, mannose, galactose, fructose, arabinose, dextrose; sugar alcohols such as sorbitol, mannitol, iditol, galactitol or their anhydro derivatives, in particular dianhydrohexites such as dianhydrosorbide (1,4:3,6-dianhydro-D-sorbide, isosorbide), dianhydromannitol (isosorbitol) or dianhydroiditol (isoiditol); sugar acids such as gluconic acid, gulonic acid, ketogulonic acid; chiral substituted glycol radicals such as mono- or oligoethylene or mono- or oligopropylene glycols in which one or more CH₂ groups are substituted by alkyl or alkoxy; amino acids such as alanine, valine, phenylglycine or phenylalanine, or sequences of from 1 to 5 of these amino acids; steroid derivatives such as cholesteryl or cholic acid radicals; terpene derivatives such as menthyl, neomenthyl, campheyl, pineyl, terpineyl, isolongifolyl, fenchyl, carreyl, myrthenyl, nopyl, geraniyl, linaloyl, neryl, citronellyl or dihydrocitronellyl.

Suitable chiral radicals and mesogenic chiral compounds are described, for example, in DE 34 25 503, DE 35 34 777, DE 35 34 778, DE 35 34 779 and DE 35 34 780, DE-A-43 42 280, EP-A-1 038 941 and DE-A-195 41 820.

Preferred dopants are selected from formulae VII to IX,

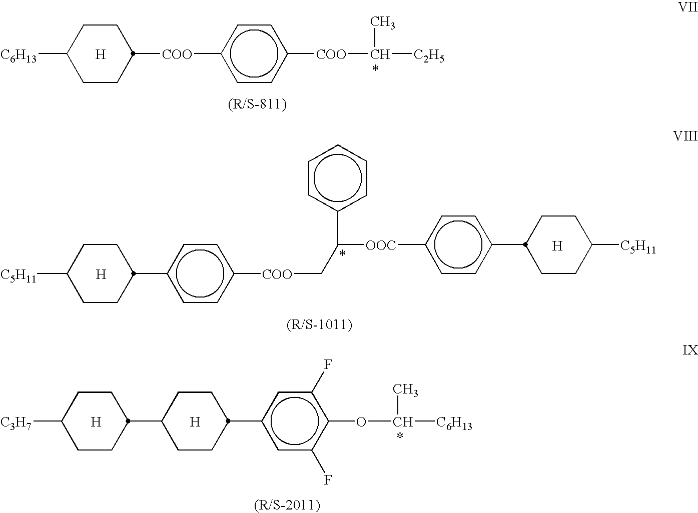

derivatives of isosorbide, isomannitol or isoiditol, in particular dianhydrosorbide derivatives of the formula X,

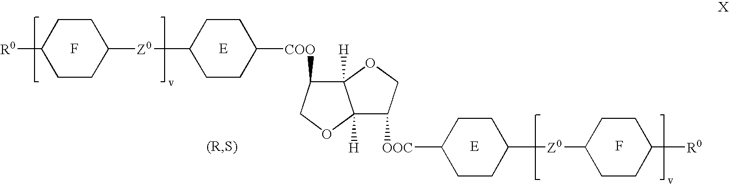

and chiral ethanediols such as diphenylethanediol (hydrobenzoin), in particular mesogenic hydrobenzoin derivatives of the formula XI

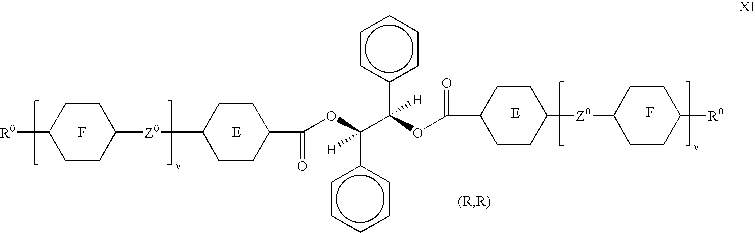

including the (R,S), (S,R), (R,R) and (S,S) enantiomers not shown in each case,

in which

E and F are each, independently of one another, 1,4-phenylene which may also be mono-, di- or trisubstituted by L, or 1,4-cyclohexylene,

L is H, F, Cl, CN or optionally halogenated alkyl, alkoxy, alkylcarbonyl, alkoxycarbonyl or alkoxycarbonyloxy having 1-7 carbon atoms,

v is 0 or 1,

Z⁰ is —COO—, —OCO—, —CH₂CH₂— or a single bond, and

R is alkyl, alkoxy, alkylcarbonyl, alkoxycarbonyl or alkylcarbonyloxy having 1-12 carbon atoms.

The compounds of the formula X are described in WO 98/00428. The compounds of the formula XI are described in GB-A-2 328 207.

Particularly preferred dopants are chiral binapthyl derivatives as described in EP 01111954.2, chiral binaphthol acetal derivatives as described in EP 00122844.4, EP 00123385.7 and EP 01104842.8, chiral TADDOL derivatives as described in WO 02/06265, and chiral dopants having at least one fluorinated bridging group and a terminal or central chiral group as described in WO 02/06196 and WO 02/06195.

The chiral binaphthyl derivatives from EP01111954.2 correspond to formula XII

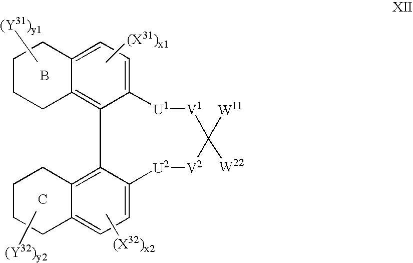

in which the individual radicals independently of one another have the following meaning

X³¹, X³², Y³¹ and Y³² are each, independently of one another, H, F, Cl, Br, I, CN, SCN, SF₅, straight-chain or branched alkyl having up to 25 carbon atoms which may be unsubstituted or mono- or polysubstituted by F, Cl, Br, I or CN, and where one or more non-adjacent CH₂ groups may also, in each case independently of one another, be replaced by —O—, —S—, —NH—, —NR⁰⁰—, —CO—, —COO—, —OCO—, —OCO—O—, —S—CO—, —CO—S—, —CH═CH— or —C≡C— in such a way that oxygen atoms and/or sulfur atoms are not linked directly to one another, a polymerizable group, or cycloalkyl or aryl having up to 20 carbon atoms which may also be mono- or polysubstituted by L or a polymerizable group,

R⁰⁰ is H or alkyl having 1 to 4 carbon atoms,

x¹ and x² are each, independently of one another, 0, 1 or 2,

y¹ and y² are each, independently of one another, 0, 1, 2, 3 or 4,

B and C are each, independently of one another, an aromatic or partially or fully saturated aliphatic six-membered ring in which one or more CH groups may be replaced by N and one or more CH₂ groups may be replaced by O and/or S,

one of the radicals W¹¹ and W²² is -Z¹¹-A¹¹-(Z²²-A²²)ₘ-R³¹ and the other is R³² or A³³, or both radicals W¹¹ and W²² are -Z¹¹-A¹¹-(Z²²-A²²)ₘ-R³¹, where W¹ and W² are not simultaneously H, or

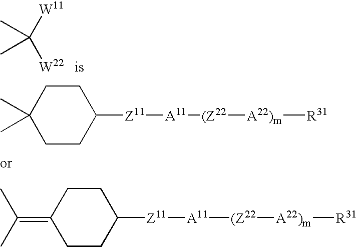

U¹ and U² are each, independently of one another, CH₂, O, S, CO or CS,

V¹ and V² are each, independently of one another, (CH₂)ₙ in which up to four non-adjacent CH₂ groups may be replaced by O and/or S, and one of the radicals V¹ and V² or, if

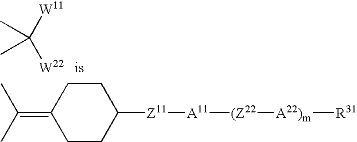

one or both radicals V¹ and V² is/are also a single bond,

n is an integer from 1 to 7,

Z¹¹ and Z²² are each, independently of one another, —O—, —S—, —CO—, —COO—, —OCO—, —O—COO—, —CO—NR⁰⁰—, —NR⁰⁰—CO—, —OCH₂—, —CH₂O—, —SCH₂—, —CH₂S—, —CF₂O—, —OCF₂—, —CF₂S—, —SCF₂—, —CH₂CH₂, —CF₂CH₂—, —CH₂CF₂—, —CF₂CF₂—, —CH═CH—, —CH═N—, —N═CH—, —N═N—, —CF═CH—, —CH═CF—, —CF═CF—, —C≡C—, —CH═CH—COO—, —OCO—CH═CH— or a single bond,

A¹¹, A²² and A³³ are each, independently of one another, 1,4-phenylene in which one or more CH groups may also be replaced by N, 1,4-cyclohexylene in which one or more non-adjacent CH₂ groups may also be replaced by O and/or S, 1,3-dioxolan-4,5-diyl, 1,4-cyclohexenylene, 1,4-bicyclo-(2,2,2)-octylene, piperidin-1,4-diyl, naphthalene-2,6-diyl, decahydronaphthalene-2,6-diyl, or 1,2,3,4-tetrahydronaphthalene-2,6-diyl, where all these groups may be unsubstituted or mono- or polysubstituted by L, and A¹¹ is also be a single bond,

L is halogen, CN, NO₂ or an alkyl, alkoxy, alkylcarbonyl or alkoxycarbonyl group having 1 to 7 carbon atoms, where one or more hydrogen atoms may be replaced by F or Cl,

m is, independently at each occurrence, 0, 1, 2 or 3, and

R³¹ and R³² are each, independently of one another H, F, Cl, Br, I, CN, SCN, OH, SF₅, straight-chain or branched alkyl having up to 25 carbon atoms which may be unsubtituted or mono- or polysubstituted by F, Cl, Br, I or CN, and where one or more non-adjacent CH₂ groups may also in each case independently of one another, be replaced by —O—, —S—, —NH—, —NR⁰⁰—, —CO—, —COO—, —OCO—, —OCO—O—, —S—CO—, —CO—S—, —CH═CH— or —C≡C— in such a way that oxygen atoms and/or sulfur atoms are not linked directly to one another, or a polymerizable group.

Particular preference is given to compounds of the formula XII in which

at least one, preferably both, of the radicals B and C are an aromatic ring,

at least one, preferably both, of the radicals B and C contain two saturated carbon atoms,

at least one, preferably both, of the radicals B and C contain four saturated carbon atoms,

at least one, preferably both, of the radicals U¹ and U² are O,

V¹ and V² are (CH₂)ₙ in which n is 1, 2, 3 or 4, and preferably one of the radicals V¹ and V² is CH₂ and the other is CH₂ or (CH₂)₂,

one of the radicals V¹ and V² is CH₂ and the other is a single bond,

at least one of the radicals Z¹¹ and Z²² is —CF₂O—, —OCF₂— or —CF₂CF₂—,

Z¹¹ is a single bond,

at least one of the radicals Z¹¹ and Z²² is —CF₂O—, —OCF₂—, —CF₂CF₂— or —CF═CF— and the others are —COO—, —OCO—, —CH₂—CH₂— or a single bond,

at least one of the radicals Z¹¹ and Z²² is —C≡C—,

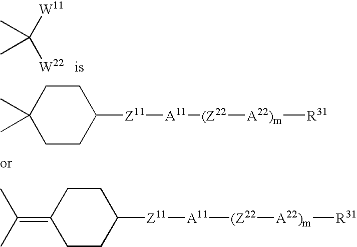

and m is 0 or 1, in particular 0, preferably m is 0 and A¹ is a single bond,

W¹¹ is R³² or A³³ in particular H or F, and W²² is Z¹¹-A¹¹-(Z²²-A²²)ₘ-R³¹, in which m is 1 or 2,

x¹ and x² are 1,

y¹ and y² are 1,

x¹, x², y¹ and y² are 0,

at least one, preferably one or two, of the radicals X³¹, X³², Y³¹ and Y³² are a polymerizable group or contain a polymerizable group,

R³¹ is a polymerizable group,

R³¹ is straight-chain alkyl having 1 to 12 carbon atoms, where one or more hydrogen atoms may also be replaced by F or CN and where one or more non-adjacent CH₂ groups may also, in each case independently of one another, be replaced by —O—, —S—, —NH—, —N(CH₃)—, —CO—, —COO—, —OCO—, —OCO—O—, —S—CO—, —CO—S—, —CH═CH— or —C≡C— in such a way that oxygen atoms and/or sulfur atoms are not linked directly to one another, particularly preferably alkyl or alkoxy having 1 to 12 carbon atoms,

X³², X³², Y³¹, Y³² and R³² are selected from H, F and straight-chain alkyl having 1 to 12 carbon atoms, where one or more hydrogen atoms may also be replaced by F or CN and where one or more non-adjacent CH₂ groups may also, in each case independently of one another, be replaced by —O—, —S—, —NH—, —N(CH₃)—, —CO—, —COO—, —OCO—, —OCO—O—, —S— CO—, —CO—S—, —CH═CH— or —C≡C— in such a way that oxygen atoms and/or sulfur atoms are not linked directly to one another, and are particularly preferably H, F or alkyl or alkoxy having 1 to 12 carbon atoms,

X³¹, X³², Y³¹ and Y³² are selected from aryl, preferably phenyl which may be unsubstituted or mono- or polysubstituted by L, preferably monosubstituted in 4 position,

L is F, Cl, CN or optionally fluorinated alkyl, alkoxy, alkylcarbonyl or alkoxycarbonyl having 1 to 7 carbon atoms,

L is F, Cl, CN, NO₂, CH₃, C₂H₅, OCH₃, OC₂H₅, COCH₃, COC₂H₅, CF₃, CHF₂, CH₂F, OCF₃ OCHF₂, OCH₂F or OC₂F₅,

A³³ is 1,4-phenylene or 1,4-cyclohexylene which may also be substituted by up to 5, preferably by 1, 2 or 3 F or Cl atoms, CN or NO₂ groups or alkyl, alkoxy, alkylcarbonyl or alkoxycarbonyl groups having 1 to 4 carbon atoms, where one or more hydrogen atoms may also be replaced by F or Cl,

A¹¹ and A²² are selected from 1,4-phenylene and trans-1,4-cyclohexylene which groups may be unsubstituted or substituted by up to 4 L radicals,

the mesogenic group Z¹¹-A¹¹-(Z²²-A²²)ₘ contains one, two or three five- or six-membered rings,

the mesogenic group Z¹¹-A¹¹-(Z²²-A²²)ₘ is bicyclohexyl, biphenyl, phenylcyclohexyl, cyclohexylphenyl or biphenylcyclohexyl, where the phenyl rings may also be substituted by one or two fluorine atoms,

The mesogenic group -Z¹¹-A¹¹-(Z²²-A²²)ₘ in formula XII is preferably selected from the following subformulae or their mirror images. Here Phe is 1,4-phenylene which may be substituted by one or more L groups, and Cyc is 1,4-cyclohexylene. Z is, independently at each occurrence, as defined above for Z¹¹.

-Phe-

-Cyc-

-Phe-Z-Phe-

-Phe-Z-Cyc-

-Cyc-Z-Cyc-

-Phe-Z-Phe-Z-Phe-

-Phe-Z-Phe-Z-Cyc-

-Phe-Z-Cyc-Z-Phe-

-Cyc-Z-Phe-Z-Cyc-

-Cyc-Z-Cyc-Z-Phe-

-Cyc-Z-Cyc-Z-Cyc-

L is preferably F, Cl, CN, NO₂, CH₃, C₂H₅, OCH₃, OC₂H₅, COCH₃, COC₂H₅, CF₃, CHF₂, CH₂F, OCF₃ OCHF₂, OCH₂F, OC₂F₅, in particular F, Cl, CN, CH₃, CHF₂, C₂H₅, OCH₃, OCHF₂, CF₃ or OCF₃, very particularly preferably F, CH₃, CF₃, OCH₃, OCHF₂ or OCF₃.

The polymerizable group is preferably selected from the formula P-Sp-X, in which

P is CH₂═CW¹—COO—,

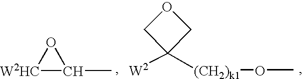

CH₂═CW²—(O)ₖ₁—, CH₃—CH═CH—O—, HO—CW²W³—, HS—CW²W³—, HW² N—, HO—CW²W³—NH—, CH₂═CW¹—CO—NH—, CH₂═CH—(COO)ₖ₁-Phe-(O)ₖ₂—, Phe-CH═CH—, HOOC—, OCN— or W⁴W⁵W⁶Si,

Sp is a spacer-group having 1 to 25 carbon atoms or a single bond,

X is —O—, —S—, —OCH₂—, —CH₂O—, —CO—, —COO—, —OCO—, —OCO—O—, —CO—N(R⁰⁰)—, —N(R⁰⁰)—CO—, —OCH₂—, —CH₂O—, —SCH₂—, —CH₂S—, —CH═CH—COO—, —OOC—CH═CH— or a single bond, and

W¹ is H, Cl, CN, phenyl or alkyl having 1 to 5 carbon atoms, in particular H, Cl or CH₃,

W² and W³ are each, independently of one another, H or alkyl having 1 to 5 carbon atoms, in particular methyl, ethyl or n-propyl,

W⁴, W⁵ and W⁶ are each, independently of one another, Cl, oxaalkyl or oxacarbonylalkyl having 1 to 5 carbon atoms,

Phe is 1,4-phenylene,

k1 and k2 are each, independently of one another, 0 or 1, and

R⁰⁰ is H or alkyl having 1 to 4 carbon atoms.

P is preferably a vinyl, acrylate, methacrylate, propenylether or epoxy group, in particular an acrylate or methacrylate group.

Sp is preferably chiral or achiral, straight-chain or branched alkylene having 1 to 20, preferably 1 to 12, carbon atoms, where one or more non-adjacent CH₂ groups may also be prelaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C— in such a way that oxygen atoms are not linked directly to one another.

Typical spacer groups are for example —(CH₂)ₚ—, —(CH₂CH₂O)ᵣ—CH₂CH₂—, —CH₂CH₂—S—CH₂CH₂— or —CH₂CH₂—NH—CH₂CH₂—, where p is an integer from 2 to 12 and r is an integer from 1 to 3.

Preferred spacer groups are for example ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyl-iminoethylene, 1-methylalkylene, ethenylene, propenylene and butenylene.

Particularly preferred compounds of the formula XII are

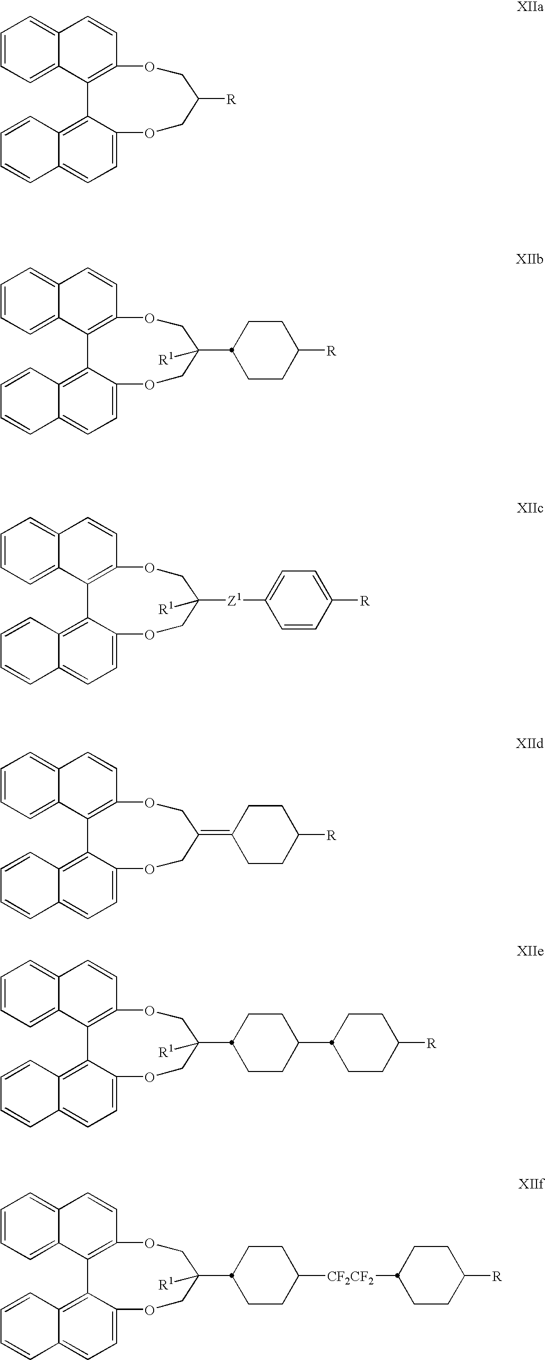

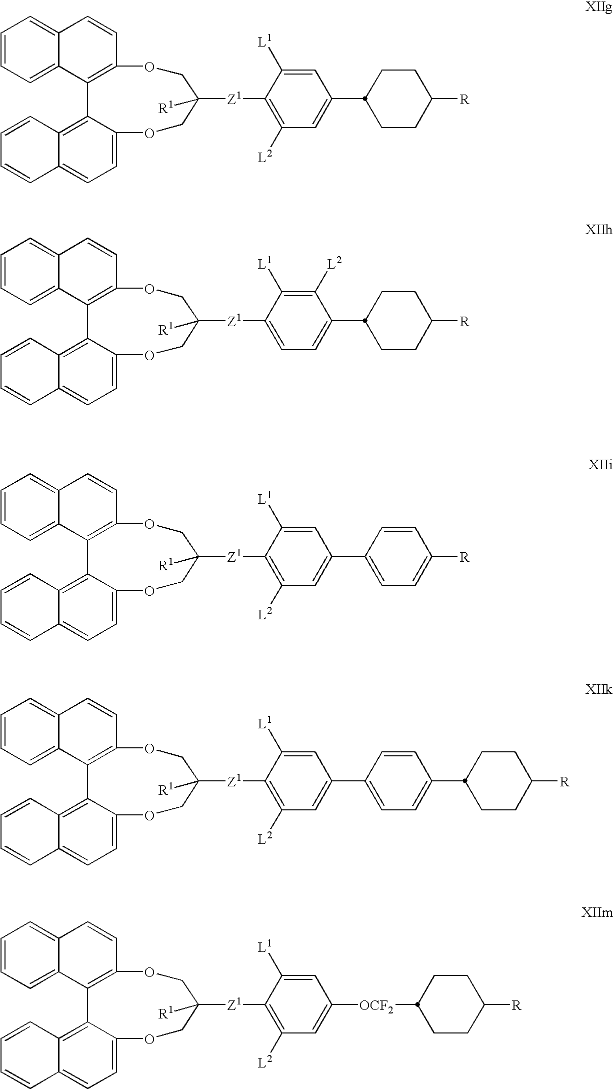

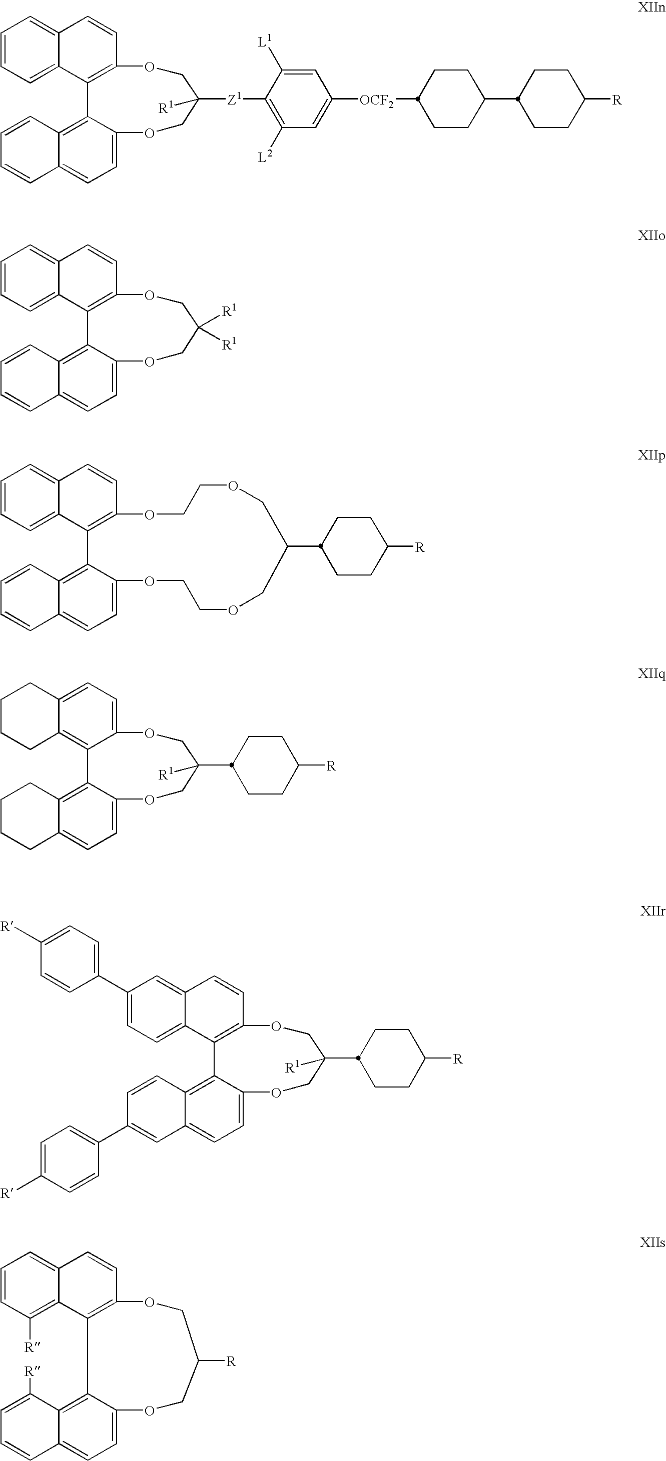

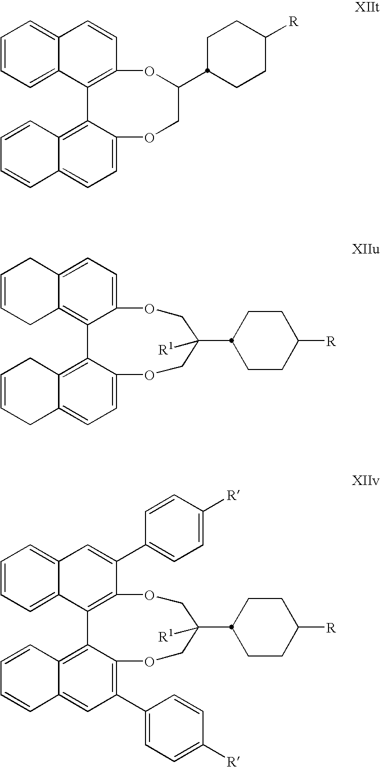

in which Z¹ is as defined for Z¹¹ in formula XII, R, R′, R″ and R¹ are as defined for R³¹ in formula XII, and L¹ and L² are H or as defined for L in formula XII.

In these preferred formulae, L¹ and L² are preferably H or F, R¹ is preferably H or F, R′ and R″ are preferably H, F, alkyl or alkoxy having 1 to 12 carbon atoms or P-Sp-X—, R″ is particularly preferably CH₃.

Very particular preference is given to compounds of the following formulae

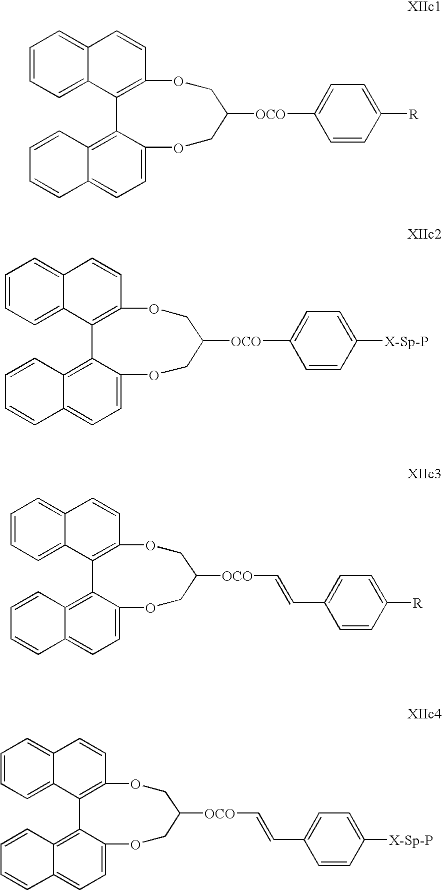

in which R, X, Sp and P are as defined above.

The chiral binaphthol acetal derivatives from EP 00122844.4, EP 00123385.7 and EP 01104842.8 correspond to the formula XIII

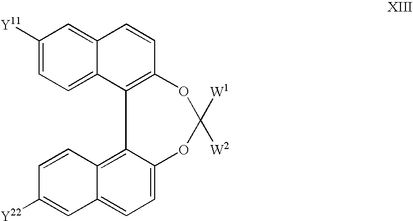

in which the individual radicals have the following meaning

Y¹¹ and Y²² are each, independently of one another, H, F, Cl, Br, I, CN, SCN, SF₅, or chiral or achiral alkyl having up to 30 carbon atoms, which may be unsubstituted or mono- or polysubstituted by F, Cl, Br, I or CN, and where one or more non-adjacent CH₂ groups may, in each case independently of one another, be replaced by —O—, —S—, —NH—, —N(CH₃)—, —CO—, —COO—, —OCO—, —OCO—O—, —S—CO—, —CO—S—, —CH═CH— or —C≡C— in such a way that oxygen atoms are not linked directly to one another, or a polymerizable group,

one of the radicals W¹ and W² is -Z¹¹-A¹¹(Z²²-A²²)ₘ-R¹¹ and the other is H, R²² or A³³, or both radicals W¹ and W² are -Z¹-A¹-(Z²-A²)ₘ-R, where W¹ and W² are not simultaneously H, or

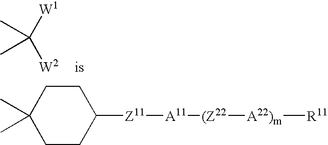

Z¹¹ and Z²² are each, independently of one another, —O—, —S—, —CO—, —COO—, —OCO—, —O—COO—, —CO—N(R⁰⁰)—, —N(R⁰⁰)—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CH═N—, —N═CH—, —N═N—, —CF═CH—, —CH═CF—, —CF═CF—, —C≡C—, —CH═CH—COO—, —OCO—CH═CH— or a single bond,

R⁰⁰ is H or alkyl having 1 to 4 carbon atoms,

A¹¹, A²² and A³³ are each, independently of one another, 1,4-phenylene in which one or more CH groups may also be replaced by N, 1,4-cyclohexylene in which one or more non-adjacent CH₂ groups may also be replaced by O and/or S, 1,3-dioxolane-4,5-diyl, 1,4-cyclohexenylene, 1,4-bicyclo-(2,2,2)-octylene, piperidine-1,4-diyl, naphthalene-2,6-diyl, decahydronaphthalene-2,6-diyl, or 1,2,3,4-tetrahydronaphthalene-2,6-diyl, where all these groups are unsubstituted or mono- or polysubstituted by halogen, CN or NO₂ or alkyl, alkoxy, alkylcarbonyl or alkoxycarbonyl having 1 to 7 carbon atoms, where one or more hydrogen atoms may be replaced by F or Cl, and A¹¹ is also a single bond,

m is 0, 1, 2 or 3, and

R¹¹ and R²² are each, independently of one another, as defined for Y¹¹.

Particular preference is given to compounds of the formula XIII in which

Y¹¹ and Y²² are H,

at least one of the radicals Z¹¹ and Z²² is —CF₂O—, —OCF₂— or —CF₂CF₂—,

one of the radicals Z¹¹ and Z²² is —CF₂O—, —OCF₂—, —CF₂CF₂— or —CF═CF— and the other is —COO—, —OCO—, —CH₂—CH₂— or a single bond,

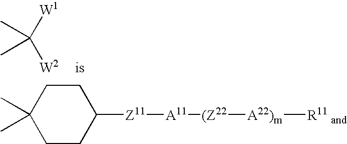

and m is 0 or 1, in particular 0,

m is 0 and A¹¹ is a single bond,

W¹ is H, R²² or A³³ and W² is -Z¹¹-A¹¹-(Z²²-A²²)ₘ-R¹¹ and m is 1 or 2.

-Z¹¹-A¹¹-(Z²²-A²²)ₘ in formula XIII is preferably a mesogenic group selected from the following subformulae or their mirror images. Here, Phe is 1,4-phenylene which may be substituted by one or more L groups, and Cyc is 1,4-cyclohexylene. Z is indepedently at each occurrence as defined above for Z¹¹. L is F, Cl, CN or optionally fluorinated alkyl, alkoxy, alkylcarbonyl or alkoxycarbonyl having 1 to 4 carbon atoms.

-Phe-

-Cyc-

-Phe-Z-Phe-

-Phe-Z-Cyc-

-Cyc-Z-Cyc-

-Phe-Z-Phe-Z-Phe-

-Phe-Z-Phe-Z-Cyc-

-Phe-Z-Cyc-Z-Phe-

-Cyc-Z-Phe-Z-Cyc-

-Cyc-Z-Cyc-Z-Phe-

-Cyc-Z-Cyc-Z-Cyc-

L is preferably F, Cl, CN, NO₂, CH₃, C₂H₅, OCH₃, OC₂H₅, COCH₃, COC₂H₅, CF₃, CHF₂, CH₂F, OCF₃ OCHF₂, OCH₂F, OC₂F₅, in particular F, Cl, CN, CH₃, CHF₂, C₂H₅, OCH₃, OCHF₂, CF₃ or OCF₃ , very particularly preferably F, CH₃, CF₃, OCH₃, OCHF₂ or OCF₃.

In another preferred embodiment, Y¹, Y² and/or R¹¹ in formula XII are a polymerizable group P-Sp-X in which

P is CH₂═CW—COO—, WCH═CH—(O)ₖ—,

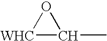

or CH₂═CH—phenyl-(O)ₖ—, W is H, CH₃ or Cl and k is 0 or 1,

Sp is a spacer group having 1 to 25 carbon atoms or a single bond,

X is —O—, —S—, —OCH₂—, —CH₂O—, —CO—, —COO—, —OCO—, —OCO—O—, —CO—N(R⁰⁰)—, —N(R⁰⁰)—CO—, —OCH₂—, —CH₂O—, —SCH₂—, —CH₂S—, —CH═CH—COO—, —OOC—CH═CH— or a single bond, and

R⁰⁰ is H or alkyl having 1 to 4 carbon atoms.

P is preferably a vinyl, acrylate, methacrylate, propenylether or epoxy group, in particular an acrylate or methacrylate group.

Sp is preferably chiral or achiral, straight-chain or branched alkylene having 1 to 20, preferably 1 to 12, carbon atoms, where one or more non-adjacent CH₂ groups may also be be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C— in such a way that oxygen atoms are not linked directly to one another.

Typical spacer groups are for example —(CH₂)ₚ—, —(CH₂CH₂O)ᵣ—CH₂CH₂—, —CH₂CH₂—S—CH₂CH₂— or —CH₂CH₂—NH—CH₂CH₂—, where p is an integer from 2 to 12 and r is an integer from 1 to 3.

Preferred spacer groups are for example ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyl-iminoethylene, 1-methylalkylene, ethenylene, propenylene and butenylene.

Particularly preferred compounds of the formula XIII are

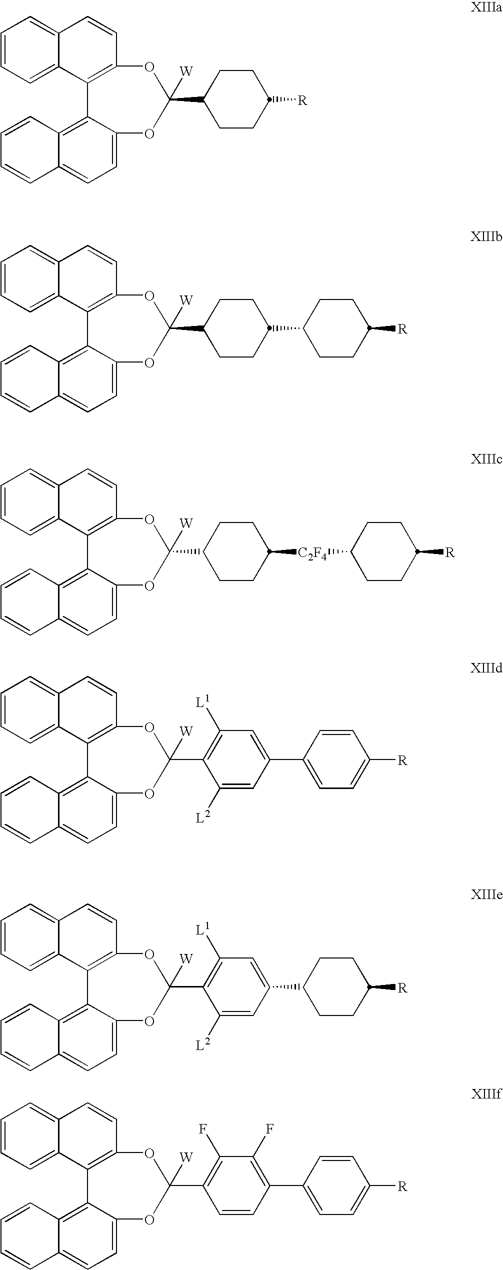

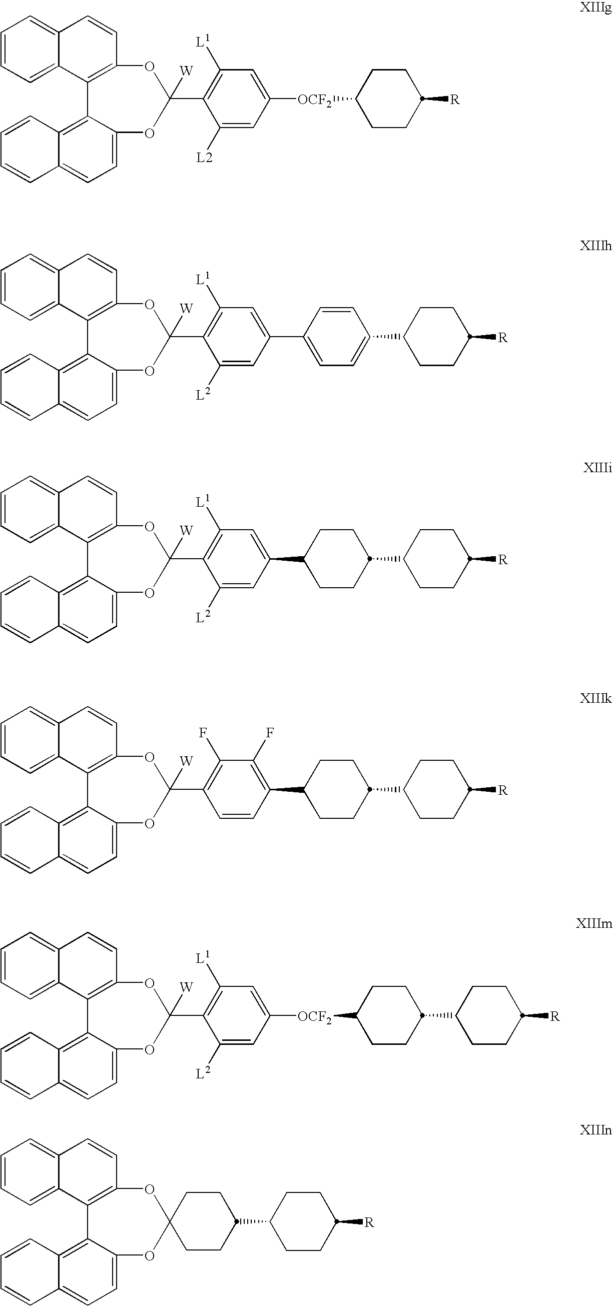

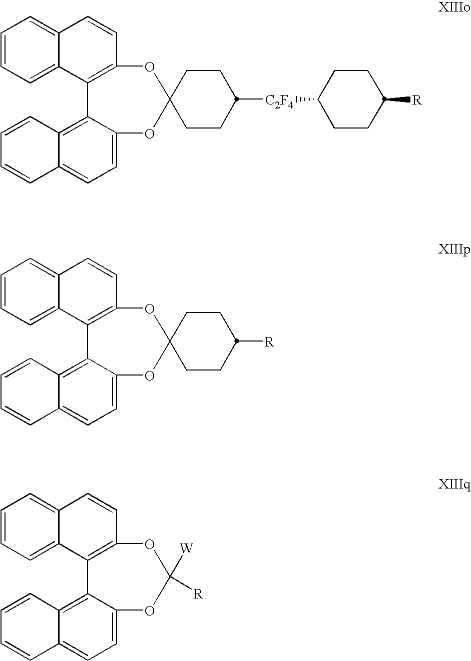

in which R is as defined for R¹¹ in formula XIII, L¹ and L² are H or F, and W is H, F, alkyl or alkoxy having 1 to 12 carbon atoms, cyclohexyl or phenyl which may also be mono- to tetrasubstituted by L as defined above. Particular preference is given to compounds of the abovementioned formulae in which W is H or F, in particular H.

The chiral TADDOL derivatives from WO 02/06265 correspond to the formula XIV

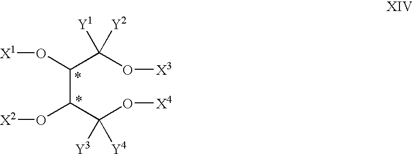

in which

X¹ and X² are H or together form a bivalent radical selected from the group comprising —CH₂—, —CHR¹¹—, —CR¹¹₂—, —SiR¹¹₂— and 1,1-cycloalkylidene,

X³ and X⁴ are as defined for X¹ and X²,

Y¹, Y², Y³ and Y⁴ may be identical or different and are each, independently of one another, R¹¹, A or M-R²²,

A is a cyclic group,

M is a mesogenic group, and

R¹¹ and R²² are each, independently of one another, H, F, Cl, Br, CN, SCN, SF₅, or chiral or achiral alkyl having up to 30 carbon atoms which may be unsbubstituted or mono- or polysubstituted by F, Cl, Br, I or CN, and where one or more non-adjacent CH₂ groups may, in each case independently of one another, be replaced by —O—, —S—, —NH—, —N(CH₃)—, —CO—, —COO—, —OCO—, —OCO—O—, —S—CO—, —CO—S—, —CH═CH— or —C≡C— in such a way that oxygen atoms are not linked directly to one another, or a polymerizable group,

where at least one of the radicals Y¹, Y², Y³ and Y⁴ is M-R²².

Particular preference is given to compounds of the formula XIV in which

Y¹, Y², Y³ and Y⁴ are identical radicals,

Y¹═Y³ and Y²═Y⁴,

one, two, three or four of the radicals Y¹, Y², Y³ and Y⁴ are M-R²², in particular those in which all radicals Y¹ to Y⁴ are M-R²² and those in which Y¹ and Y³ are M-R²² and Y² and Y⁴ are A,

X¹ and X² together are a bivalent radical —CH₂—, —CHR¹¹— or —CR¹¹₂— in which R¹¹ is preferably alkyl having 1 to 8 carbon atoms, in particular methyl, ethyl or propyl,

X¹ and X² together are a 1,1-cycloalkylidene radical, in particular 1,1-cyclopentylidene or 1,1-cyclohexylidene,

X³ and X⁴ are H,

R²² is not H.

The cyclic group A in formula XIV is preferably phenyl in which one or more CH groups may also be replaced by N, cyclohexyl in which one or two non-adjacent CH₂ groups may also be replaced by O and/or S, 1,3-dioxolan-2-yl, cyclohexenyl, bicyclo-(2,2,2)-octylene, piperidin-1- or 4-yl, naphthalen-2- or 6-yl, decahydronaphthalen-2- or 6-yl, or 1,2,3,4-tetrahydronaphthalen-2- or 6-yl, where all these groups are unsubstituted or mono- or polysubstituted by halogen, CN or NO₂ or alkyl, alkoxy, alkylcarbonyl or alkoxycarbonyl having 1 to 7 carbon atoms in which one or more hydrogen atoms may be replaced by F or Cl, particularly preferably phenyl or cyclohexyl.

The mesogenic group M is preferably

A¹¹-(Z¹¹-A²²)ₘ-

in which

A¹¹ and A²² are each, independently of one another, 1,4-phenylene in which one or more CH groups may also be prelaced by N, 1,4-cyclohexylene in which one or two non-adjacent CH₂ groups may also be replaced by O and/or S, 1,3-dioxolane-4,5-diyl, cyclohexenylene, bicyclo-(2,2,2)-octylene, piperidine-1,4-diyl, naphthalene-2,6-diyl, decahydronaphthalene-2,6-diyl, or 1,2,3,4-tetrahydronaphthalene-2,6-diyl, where all these groups are unsubstituted or mono- or polysubstituted by halogen, CN or NO₂ or alkyl, alkoxy, alkylcarbonyl or alkoxycarbonyl having 1 to 7 carbon atoms in which one or more hydrogen atoms may be replaced by F or Cl,

Z¹¹ is independently at each occurrence —O—, —S—, —CO—, —COO—, —OCO—, —O—COO—, —CO—N(R⁰⁰)—, —N(R⁰⁰)—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—COO—, —OCO—CH═CH— or a single bond,

R⁰⁰ is H or alkyl having 1 to 4 carbon atoms, and

m is 1, 2, 3 or 4.

M in formula XIV is preferably a mesogenic group selected from the following subformulae. Here, Phe is 1,4-phenylene which may be substituted by one or more L groups, and Cyc is 1,4-cyclohexylene. Z is independently at each occurrence as defined above for Z¹¹. L is F, Cl, CN or optionally fluorinated alkyl, alkoxy, alkylcarbonyl or alkoxycarbonyl having 1 to 4 carbon atoms.

-Phe-Z-Phe-

-Phe-Z-Cyc-

-Cyc-Z-Cyc-

-Phe-Z-Phe-Z-Phe-

-Phe-Z-Phe-Z-Cyc-

-Phe-Z-Cyc-Z-Phe-

-Cyc-Z-Phe-Z-Cyc-

-Cyc-Z-Cyc-Z-Phe-

-Cyc-Z-Cyc-Z-Cyc-

L is preferably F, Cl, CN, NO₂, CH₃, C₂H₅, OCH₃, OC₂H₅, COCH₃, COC₂H₅, CF₃, CHF₂, CH₂F, OCF₃ OCHF₂, OCH₂F, OC₂F₅, in particular F, Cl, CN, CH₃, C₂H₅, OCH₃, CF₃ or OCF₃, particularly preferably F, CH₃, CF₃, OCH₃ or OCF₃.

In another preferred embodiment, Y¹, Y² or R in formula XIV are a polymerizable group P-Sp-X as defined above.

Particularly preferred compounds of the formula XIV are

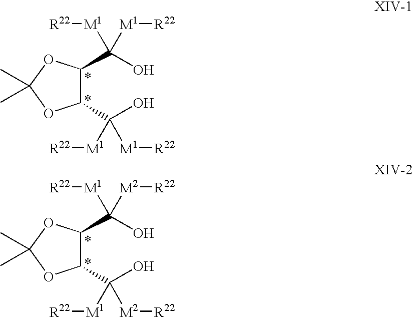

in which R²² is as defined in formula XIV and M¹ and M² are different mesogenic groups as defined above for M.

Particularly preferred compounds of the formula XIV and of the preferred subformulae are those in which M¹-R²² and M²-R²² are a group selected from the following formulae

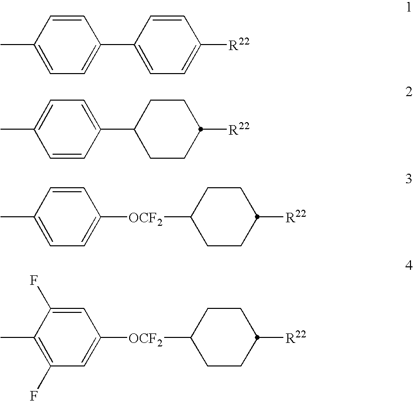

in which R²² is as defined in formula XIV and the phenyl rings may also be mono- to tetrasubstituted by L as defined above.

The chiral dopants having a fluorinated bridging group and a terminal chiral group from WO 02/06196 corrsepond to formula XV

R¹¹—X¹¹-A¹¹-(Z¹¹-A²²)ₘ-X²²—R²² XV

in which

R¹¹ and R²² are each, independently of one another, H, F, Cl, Br, CN, SCN, SF₅, or chiral or achiral alkyl having up to 30 carbon atoms which may be unsubstituted or mono- or polysubstituted by F, Cl, Br, I or CN, and where one or more non-adjacent CH₂ groups may, in each case independently of one another, be replaced by —O—, —S—, —NH—, —N(CH₃)—, —CO—, —COO—, —OCO—, —OCO—O—, —S—CO—, —CO—S—, —CH═CH— or —C≡C— in such a way that oxygen atoms are not linked directly to one another, a chiral radical containing one or more aromatic or aliphatic ring groups which may also comprise fused or spiro-linked rings and one or more heteroatoms, or a polymerizable group,

X¹¹ and X²² are each, independently of one another, —CF₂O—, —OCF₂—, —CF₂S—, —SCF₂—, —CF₂CH₂—, —CH₂CF₂—, —CF₂CF₂—, —CF═CH—, —CH═CF—, —CF═CF— or a single bond,

Z¹¹ is independently at each occurrence —O—, —S—, —CO—, —COO—, —OCO—, —O—COO—, —CO—N(R⁰⁰)—, —N(R⁰⁰)—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—COO—, —OCO—CH═CH— or a single bond,

R⁰⁰ is H or alkyl having 1 to 4 carbon atoms,

A¹¹ and A²² are each, independently of one another, 1,4-phenylene in which one or more CH groups may also be replaced by N, 1,4-cyclohexylene in which one or two non-adjacent CH₂ groups may also be replaced by O and/or S, 1,3-dioxolane-4,5-diyl, cyclohexenylene, bicyclo-(2,2,2)-octylene, piperidine-1,4-diyl, naphthalene-2,6-diyl, decahydronaphthalene-2,6-diyl, or 1,2,3,4-tetrahydronaphthalene-2,6-diyl, where all these groups are unsubstituted or mono- or polysubstituted by halogen, CN or NO₂ or alkyl, alkoxy, alkylcarbonyl or alkoxycarbonyl having 1 to 7 carbon atoms in which one or more hydrogen atoms may be replaced by F or Cl, and

m is 1, 2, 3, 4 or 5,

where at least one of the radicals X¹¹, X²² and Z¹¹ is —CF₂O—, —OCF₂—, —CF₂S—, —SCF₂—, —CF₂CH₂—, —CF₂CF₂—, —CF═CH— or —CF═CF— and at least one of the radicals R¹¹ and R²² is a chiral group.

If R¹¹ or R²² in formula XV are a chiral group, they are preferably selected from the following formula

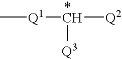

in which

Q¹ is alkylene or alkyleneoxy having 1 to 9 carbon atoms or a single bond,

Q² is alkyl or alkoxy having 1 to 10 carbon atoms, unsubstituted or mono- or polysubstituted by F, Cl, Br or CN, where one or more non-adjacent CH₂ groups may also, in each case independently of one another, be replaced by —C≡C—, —CH═CH—, —O—, —S—, —NH—, —N(CH₃)—, —CO—, —COO—, —OCO—, —OCO—O—, —S—CO— or —CO—S— in such a way that oxygen atoms are not linked directly to one another,

Q³ is F, Cl, Br, CN or alkyl or alkoxy as defined for Q², but different from Q²

If Q¹ is alkyleneoxy, the oxygen atom is preferably adjacent to the chiral carbon atom.

Preferred chiral groups are 2-alkyl, 2-alkoxy, 2-methylalkyl, 2-methylalkoxy, 2-fluoroalkyl, 2-fluoroalkoxy, 2-(2-ethyne)-alkyl, 2-(2-ethyne)-alkoxy, 1,1,1-trifluoro-2-alkyl and 1,1,1-trifluoro-2-alkoxy.

Particularly preferred chiral groups are 2-butyl (=1-methylpropyl), 2-methylbutyl, 2-methylpentyl, 3-methylpentyl, 2-ethylhexyl, 2-propylpentyl, in particular 2-methylbutyl, 2-methylbutoxy, 2-methylpentoxy, 3-methylpentoxy, 2-ethylhexoxy, 1-methylhexoxy, 2-octyloxy, 2-oxa-3-methylbutyl, 3-oxa4-methylpentyl, 4-methylhexyl, 2-hexyl, 2-octyl, 2-nonyl, 2-decyl, 2-dodecyl, 6-methoxyoctoxy, 6-methyloctoxy, 6-methyloctanoyloxy, 5-methylheptyloxycarbonyl, 2-methylbutyryloxy, 3-methylvaleroyloxy, 4-methylhexanoyloxy, 2-chloropropionyloxy, 2-chloro-3-methylbutyryloxy, 2-chloro4-methylvaleryloxy, 2-chloro-3-methylvaleryloxy, 2-methyl-3-oxapentyl, 2-methyl-3-oxahexyl, 1-methoxypropyl-2-oxy, 1-ethoxypropyl-2-oxy, 1-propoxypropyl-2-oxy, 1-butoxypropyl-2-oxy, 2-fluorooctyloxy, 2-fluorodecyloxy, 1,1,1-trifluoro-2-octyloxy, 1,1,1-trifluoro-2-octyl, 2-fluoromethyloctyloxy. Particular preference is given to 2-hexyl, 2-octyl, 2-octyloxy, 1,1,1-trifluoro-2-hexyl, 1,1,1-trifluoro-2-octyl and 1,1,1-trifluoro-2-octyloxy.

In a preferred embodiment, R¹¹ or R²² are a chiral radical containing one or more aromatic or aliphatic ring groups which may also comprise fused or spiro-linked rings and one or more heteroatoms, in particular nitrogen and/or oxygen atoms.

Preferred chiral radicals of this type are for example cholesteryl, terpenoid radicals such as those described in WO 96/17901, preferably selected from menthyl, neomenthyl, campheyl, pineyl, terpineyl, isolongifolyl, fenchyl, carreyl, myrthenyl, nopyl, geraniyl, linaloyl, neryl, citronellyl and dihydrocitronellyl, in particular menthyl, menthone derivatives such as

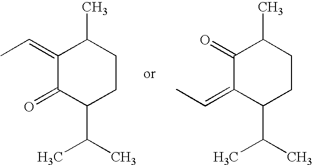

or terminal chiral sugar derivatives containing mono- or bicyclic pyranose or furanose groups such as those described in WO 95/16007.

Particularly preferred compounds of the formula XV are

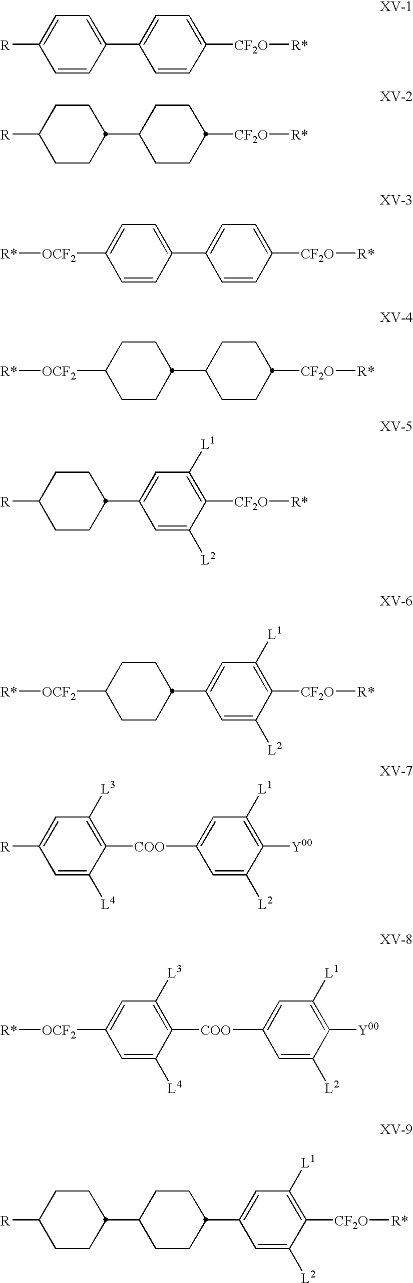

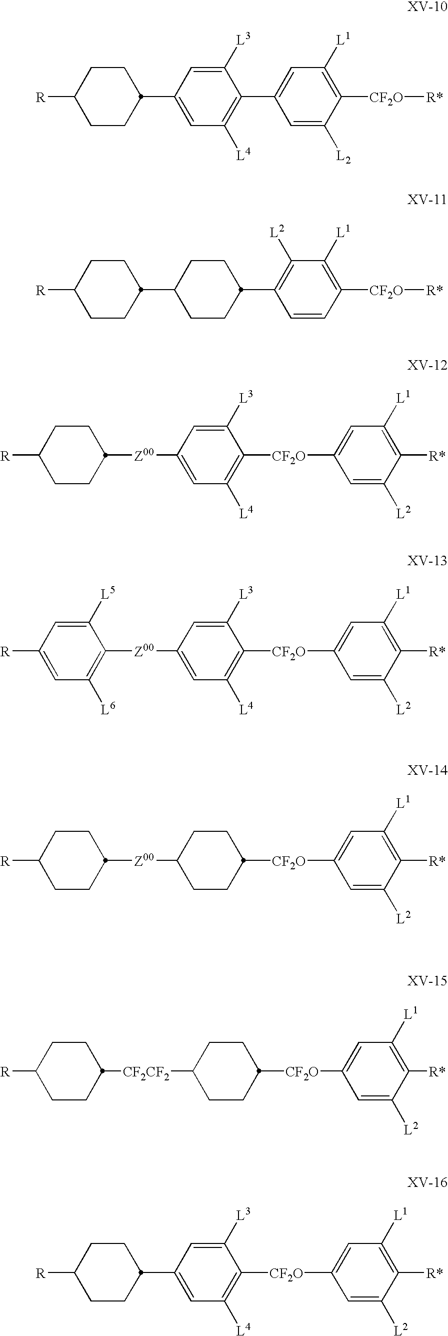

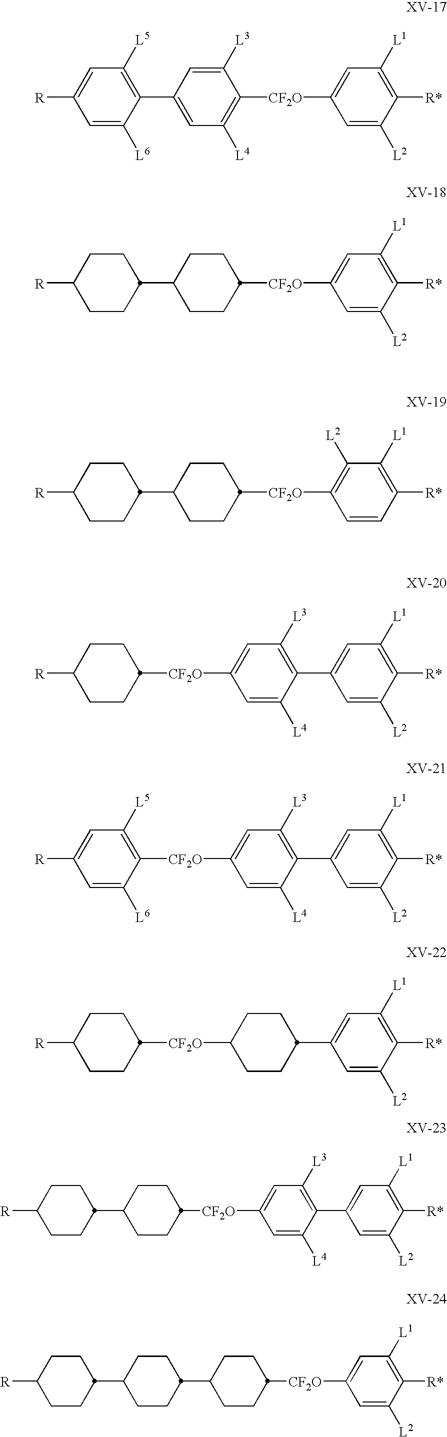

in which

R is as defined for R¹¹ in formula XV,

R* is a chiral group as defined for R¹¹ in formula XV or having one of the abovementioned preferred meanings,

Y⁰⁰ is F, Cl, CN, CF₃, CHF₂, CH₂F, OCF₃, OCHF₂, OCH₂F, C₂F₅ or OC₂F₅,

Z⁰⁰ is —COO—, —OCO—, —CH₂CH₂—, —CF₂CF₂—, —CF₂O— or —OCF₂—, and

L¹, L², L³, L⁴, L⁵ and L⁶ are each, independently of one another, H or F.

Particular preference is given to compounds in which at least one, preferably both, of the radicals L¹ and L² are F. R is preferably an achiral group. R* is preferably

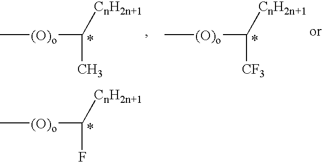

in which o is 0 or 1, and o is 0 if R* is adjacent to a CF₂O group, and n is an integer from 2 to 12, preferably from 3 to 8, particularly preferably 4, 5 or 6. * denotes a chiral carbon atom.

The chiral dpoants having a fluorinated bridging group and a central chiral group from WO 02/06195 corrsepond to formula XVI

R¹¹—X³³-(A¹¹-Z¹¹)ₘ-G-(Z²²-A²²)ₙ-X⁴⁴-R²² XVI

in which

R¹¹ and R²² are each, independently of one another, H, F, Cl, Br, CN, SCN, SF₅, or chiral or achiral alkyl having up to 30 carbon atoms which may be unsubstituted or mono- or polysubstituted by F, Cl, Br, I or CN, and where one or more non-adjacent CH₂ groups may, in each case independently of one another, be replaced by —O—, —S—, —NH—, —N(CH₃)—, —CO—, —COO—, —OCO—, —OCO—O—, —S—CO—, —CO—S—, —CH═CH— or —C≡C— in such a way that oxygen atoms are not linked directly to one another, or a polymerizable group,

X³³, X⁴⁴, Z¹¹ and Z²² are each, independently of one another, —O—, —S—, —CO—, —COO—, —OCO—, —O—COO—, —CO—N(R⁰⁰)—, —N(R⁰⁰)—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—COO—, —OCO—CH═CH— or a single bond,

R⁰⁰ is H or alkyl having 1 to 4 carbon atoms,

A¹¹ and A²² are each, independently of one another, 1,4-phenylene in which one or more CH groups may also be replaced by N, 1,4-cyclohexylene in which one or two non-adjacent CH₂ groups may also be replaced by O and/or S, 1,3-dioxolane-4,5-diyl, cyclohexenylene, bicyclo-(2,2,2)-octylene, piperidine-1,4-diyl, naphthalene-2,6-diyl, decahydronaphthalene-2,6-diyl, or 1,2,3,4-tetrahydronaphthalene-2,6-diyl, where all these groups are unsubstituted or mono- or polysubstituted by halogen, CN or NO₂ or alkyl, alkoxy, alkylcarbonyl or alkoxycarbonyl having 1 to 7 carbon atoms in which one or more hydrogen atoms may be replaced by F or Cl,

m and n are each, independently of one another, 1, 2, 3 or 4, and

G is a bivalent chiral group,

where at least one of the radicals X³³, X⁴⁴, Z¹¹ and Z²² is —CF₂O—, —OCF₂—, —CF₂S—, —SCF₂—, —CF₂CH₂—, —CF₂CF₂—, —CF═CH— or —CF═CF—.

G in formula XVI is preferably a chiral bivalent group from the group comprising sugar derivatives, binaphthyl derivatives and optically active glycols, in particular alkyl- or arylethane-1,2-diols. Particularly preferred sugar derivatives are mono- and bicyclic pentose and hexose groups.

Particular preference is given to the following groups G

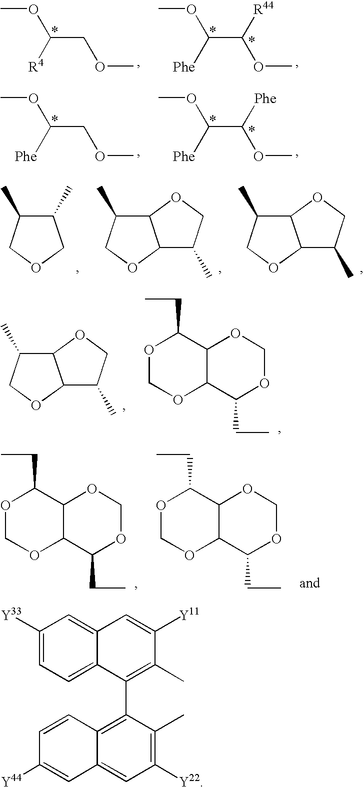

in which Phe is as defined above, R⁴⁴ is F or optionally fluorinated alkyl having 1 to 4 carbon atoms and Y¹¹, Y²², Y³³ and Y⁴⁴ are as defined for R¹ in formula XV.

G is preferably dianhydrohexitol, in particular

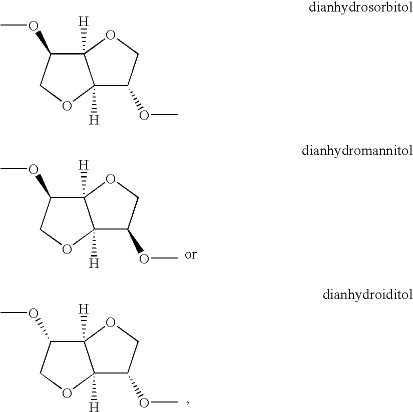

particularly preferably dianhydrosorbitol,

substituted ethanediol such as

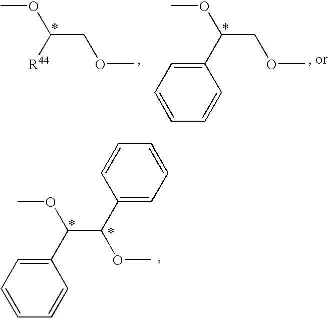

in which R⁴⁴ is F, CH₃ or CF₃,

oder optionally substituted binaphthyl

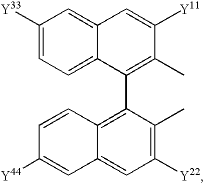

in which Y¹¹, Y²², Y²³ and Y⁴⁴ are H, F or optionally fluorinated alkyl having 1 to 8 carbon atoms.

Particularly preferred compounds of the formula XVI are

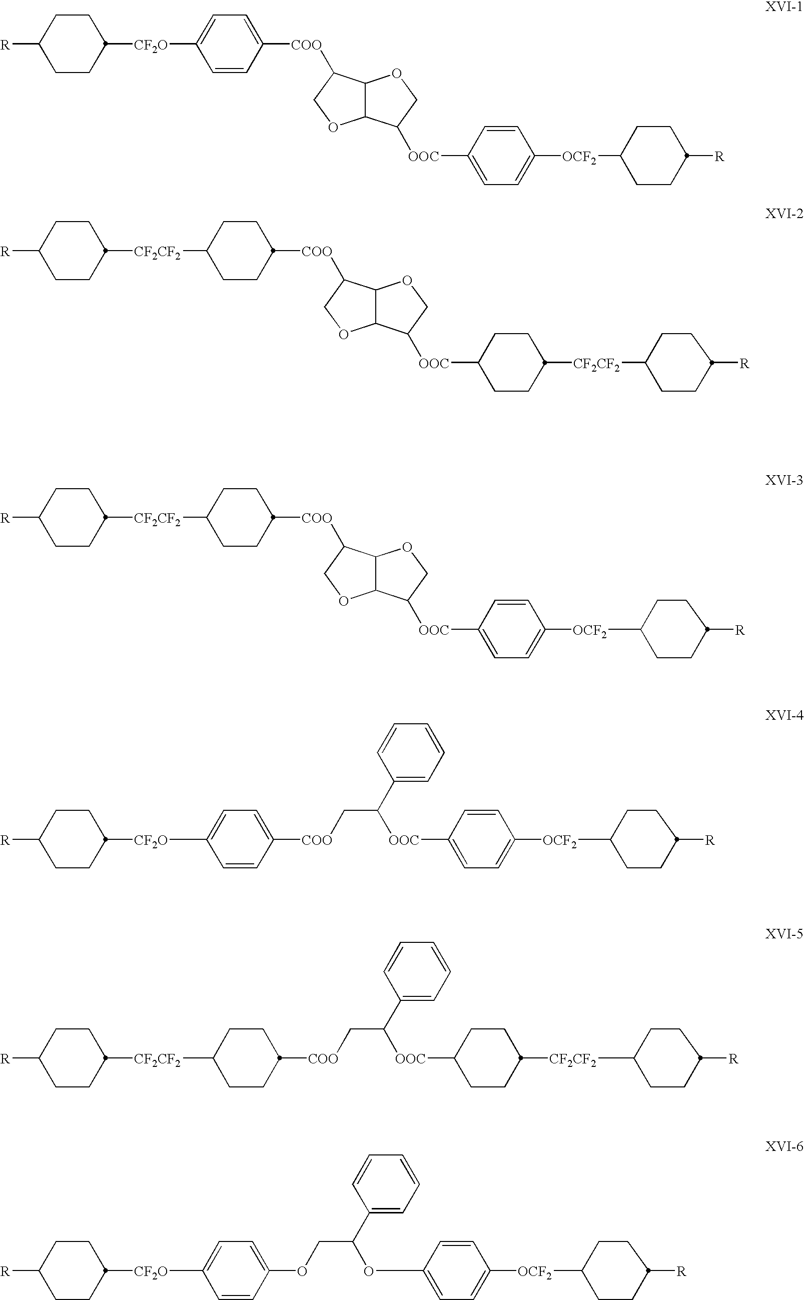

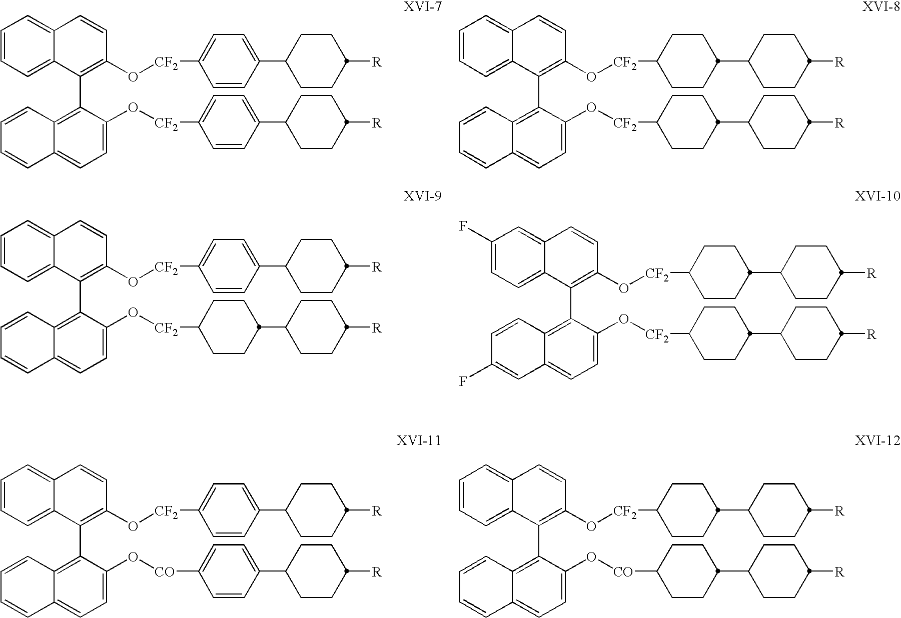

in which R is as defined for R¹¹ in formula XVI, and the phenyl rings may also be mono- to tetrasubstituted by L as defined above.

Especially the dopants of the abovementioned formulae X, XI, XII, XIII, XIV, XV and XVI exhibit a good solubility in the nematic component and induce a cholesteric structure having a high twist and a low temperature dependence of the helical pitch and the reflection wavelength. For this reason, it is possible to obtain novel LC media which have reflection colours in the visible wavelength range having a high brilliancy and a low temperature dependence and which are especially suitable for use in SSCT and PSCT displays even when only one of these dopants is used in low amounts.

This is a signifcant advantage over the CLC media of the prior art which usually require at least two dopants having opposite temperature dependence of the twist (for example one dopant having a positive temperature dependence, i.e. increasing twist with increasing temperature, and one dopant having a negative temperature dependence) to achieve a temperature compensation of the reflection wavelength. Moreover, the known CLC media often require large amounts of dopants to achieve reflection in the visible range.

A particularly preferred embodiment of the invention therefore relates to a CLC medium and a CLC display containing this medium as described hereinbefore and hereinafter, in which the chiral component does not comprise more than one chiral compound, preferably in an amount of 15% or less, in particular 10% or less, particularly preferably 5% or less. The chiral compound in these media is particularly preferably selected from the formulae X, XI, XII, XIII, XIV, XV and XVI including the preferred subformulae thereof. A CLC medium of this preferred embodiment has a low dependence of the reflection wavelength λ on the temperature T over a broad temperature range.

Particular preference is given to CLC media according to the invention which have a temperature dependence dλ/dT of 0.6 nm/° C. or less, in particular 0.3 nm/° C. or less, very particularly preferably 0.15 nm/° C. or less, preferably in the range between 0 and 50° C., in particular between −20 and 60° C., particularly preferably between −20 and 70° C., very particularly preferably in the range from −20° C. to a temperature 10° C., in particular 5° C., below the clearing point.

Unless otherwise indicated, dλ/dT is the local slope of the function λ(T), where a nonlinear function λ(T) is described approximately by a 2^{nd} or 3^{rd} order polynomial.

Another preferred embodiment relates to a CLC medium according to the invention which comprises one or more compounds having at least one polymerizable group. Such CLC media are particularly suitable for use e.g. in polymer gel displays or PSCT displays. The polymerizable compounds can be part of the nematic and/or chiral component or form an additional component of the medium.

Suitable polymerizable compounds are known to the person skilled in the art and have been described in the prior art. Examples of particularly suitable compounds are compounds having a group P as described for formula XII, in particular alkyl or aryl acrylates, methacrylates and epoxides. The polymerizable compounds may additionally be mesogenic or liquid-crystalline. They can contain one or more, preferably two, polymerizable groups. Typical examples of non-mesogenic compounds having two polymerizable groups are alkyl diacrylates or alkyl dimethacrylates having alkyl groups of 1 to 20 carbon atoms. Typical examples of non-mesogenic compounds having more than two polymerizable groups are trimethylolpropane trimethacrylate or pentaerythritol tetraacrylate.

Preferred chiral polymerizable mesogenic compunds are compounds of the formulae XII to XVI containing one or more radicals containg a group P as defined for formula XII.

Further suitable polymerizable compounds are described, for example, in WO 93/22397, EP 0 261 712, DE 195 04 224, WO 95/22586 and WO 97/00600. Typical examples for suitable polymerizable mesogenic compounds are shown in the following list which is intended to illustrate the subject-matter of the present invention without limiting it:

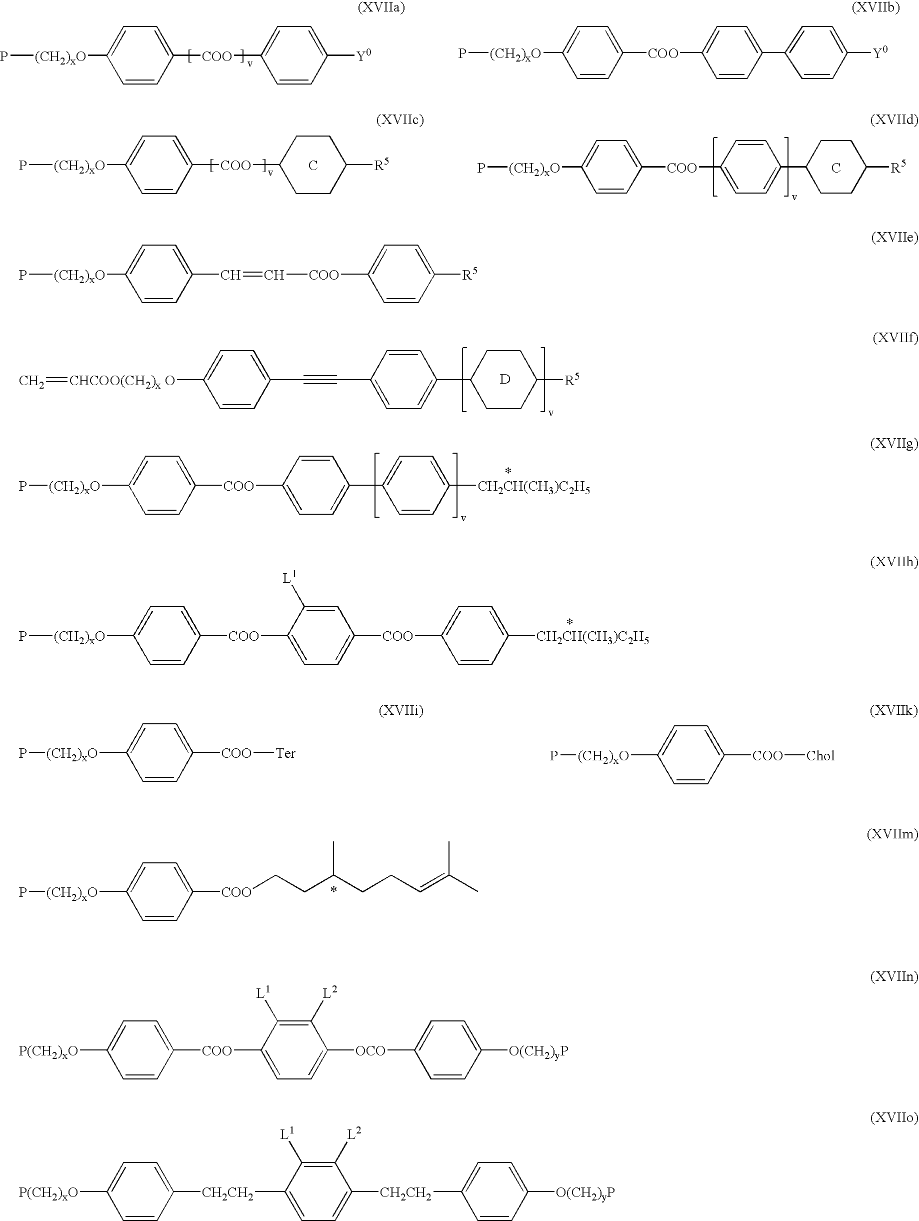

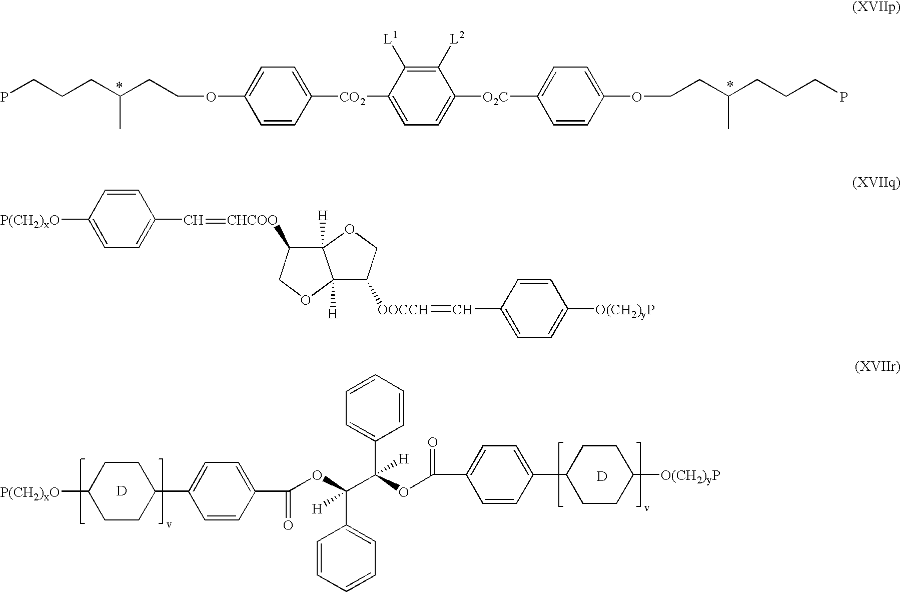

In these compounds, P is a polymerizable group as defined in XII, x and y are identical or different integers from 1 to 12, C and D are 1,4-phenylene or 1,4-cyclohexylene, v is 0 or 1, Y⁰ is a polar group, R⁵ is a nonpolar alkyl or alkoxy group, Ter is a terpenoid radical such as menthyl, Chol is a cholesteryl radical, L¹ and L² are each, independently of one another, H, F, Cl, CN, OH, NO₂ or optionally halogenated alkyl, alkoxy, alkylcarbonyl or alkoxycarbonyl having 1 to 7 carbon atoms.

The polar group Y⁰ is preferably CN, NO₂, halogen, OCH₃, OCN, SCN, COR⁶, COOR⁶ or mono-, oligo- or polyfluorinated alkyl or alkoxy having 1 to 4 carbon atoms. R⁶ is optionally fluorinated alkyl having 1 to 4, preferably 1, 2 or 3 carbon atoms. Y⁰ is particularly preferably F, Cl, CN, NO₂, OCH₃, COCH₃, COC₂H₅, COOCH₃, COOC₂H₅, CF₃, C₂F₅, OCF₃, OCHF₂ or OC₂F₅, in particular F, Cl, CN, OCH₃ or OCF₃.

The nonpolar group R⁵ is preferably alkyl having 1 or more, in particular 1 to 15, carbon atoms or alkoxy having 2 or more, in particular 2 to 15, carbon atoms.

The abovementioned polymerizable compounds can be prepared by methods which are known per se and which are described in standard works of organic chemistry, for example Houben-Weyl, Methoden der organischen Chemie, Thieme-Verlag, Stuttgart.

In the abovementioned formulae I to XVII, the term “fluorinated alkyl or alkoxy having 1 to 3 carbon atoms” preferably means CF₃, OCF₃, CFH₂, OCFH₂, CF₂H, OCF₂H, C₂F₅, OC₂F₅, CFHCF₃, CFHCF₂H, CFHCFH₂, CH₂CF₃, CH₂CF₂H, CH₂CFH₂, CF₂CF₂H, CF₂CFH₂, OCFHCF₃, OCFHCF₂H, OCFHCFH₂, OCH₂CF₃, OCH₂CF₂H, OCH₂CFH₂, OCF₂CF₂H, OCF₂CFH₂, C₃F₇ or OC₃F₇, in particular CF₃, OCF₃, CF₂H, OCF₂H, C₂F₅, OC₂F₅, CFHCF₃, CFHCF₂H, CFHCFH₂, CF₂CF₂H, CF₂CFH₂, OCFHCF₃, OCFHCF₂H, OCFHCFH₂, OCF₂CF₂H, OCF₂CFH₂, C₃F₇ or OC₃F₇, particularly preferably OCF₃ or OCF₂H.

The term “alkyl” encompasses straight-chain and branched alkyl groups having 1-7 carbon atoms, particularly the straight-chain groups methyl, ethyl, propyl, butyl, pentyl, hexyl and heptyl. Groups having 2-5 carbon atoms are generally preferred.

The term “alkenyl” encompasses straight-chain and branched alkenyl groups having 2-7 carbon atoms, in particular the straight-chain groups. Particularly preferred alkenyl groups are C₂-C₇-1E-alkenyl, C₄-C₇-3E-alkenyl, C₅-C₇-4-alkenyl, C₆-C₇-5-alkenyl and C₇-6-alkenyl, in particular C₂-C₇-1E-alkenyl, C₄-C₇-3E-alkenyl and C₅-C₇-4-alkenyl. Examples of preferred alkenyl groups are vinyl, 1E-propenyl, 1E-butenyl, 1E-pentenyl, 1E-hexenyl, 1E-heptenyl, 3-butenyl, 3E-pentenyl, 3E-hexenyl, 3E-heptenyl, 4-pentenyl, 4Z-hexenyl, 4E-hexenyl, 4Z-heptenyl, 5-hexenyl, 6-heptenyl and the like. Groups having up to 5 carbon atoms are generally preferred.

The term “fluoroalkyl” preferably encompasses straight-chain groups with terminal fluorine, i.e. fluoromethyl, 2-fluoroethyl, 3-fluoropropyl, 4-fluorobutyl, 5-fluoropentyl, 6-fluorohexyl and 7-fluoroheptyl. Other positions of fluorine are not precluded, however.

The term “oxaalkyl” preferably encompasses straight-chain radicals of the formula CₙH₂ₙ₊₁—O—(CH₂)ₘ, where n and m are each, independently of one another, from 1 to 6. Preferably, n=1 and m is 1 to 6.

Halogen is preferably F or Cl, in particular F.

If one of the abovementioned radicals is an alkyl radical and/or an alkoxy radical, this can be straight-chain or branched. It is preferably straight-chain, has 2, 3, 4, 5, 6 or 7 carbon atoms and accordingly is preferably ethyl, propyl, butyl, pentyl, hexyl, heptyl, ethoxy, propoxy, butoxy, pentoxy, hexoxy or heptoxy, furthermore methyl, octyl, nonyl, decyl, undecyl, dodecyl, tridecyl, tetradecyl, pentadecyl, methoxy, octoxy, nonoxy, decoxy, undecoxy, dodecoxy, tridecoxy or tetradecoxy.

Oxaalkyl is preferably straight-chain 2-oxapropyl (=methoxymethyl), 2-(=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl, or 2-, 3-, 4-, 5-, 6-, 7-, 8- or 9-oxadecyl.

If one of the abovementioned radicals is an alkyl radical in which one CH₂ group has been replaced by —CH═CH—, this can be straight-chain or branched. It is preferably straight-chain and has 2 to 10 carbon atoms. Accordingly, it is in particular vinyl, prop-1- or prop-2-enyl, but-1-, -2- or but-3-enyl, pent-1-, -2-, -3- or pent-4-enyl, hex-1-, -2-, -3-, -4- or hex-5-enyl, hept-1-, -2-, -3-, 4-, -5- or hept-6-enyl, oct-1-, -2-, -3-, 4-, -5-, -6- or oct-7-enyl, non-1-, -2-, -3-, -4-, -5-, -6-, -7- or non-8-enyl, dec-1-, -2-, -3-, -4-, -5-, -6-, -7-, -8- or dec-9-enyl.

If one of the abovementioned radicals is an alkyl radical in which one CH₂ group has been replaced by —O— and one has been replaced by —CO—, these are preferably adjacent. These thus contain an acyloxy group —CO—O— or an oxycarbonyl group —O—CO—. These are preferably straight-chain and have 2 to 6 carbon atoms.

They are accordingly in particular acetyloxy, propionyloxy, butyryloxy, pentanoyloxy, hexanoyloxy, acetyloxymethyl, propionyloxymethyl, butyryloxymethyl, pentanoyloxymethyl, 2-acetyloxyethyl, 2-propionyloxyethyl, 2-butyryloxyethyl, 3-acetyloxypropyl, 3-propionyloxypropyl, 4-acetyloxybutyl, methoxycarbonyl, ethoxycarbonyl, propoxycarbonyl, butoxycarbonyl, pentoxycarbonyl, methoxycarbonylmethyl, ethoxycarbonylmethyl, propoxycarbonylmethyl, butoxycarbonylmethyl, 2-(methoxycarbonyl)ethyl, 2-(ethoxycarbonyl)ethyl, 2-(propoxycarbonyl)ethyl, 3-(methoxycarbonyl)propyl, 3-(ethoxycarbonyl)propyl or 4-(methoxycarbonyl)butyl.

If one of the abovementioned radicals is an alkyl radical in which one CH₂ group has been replaced by unsubstituted or substituted —CH═CH— and an adjacent CH₂ group has been replaced by CO or CO—O or O—CO, this can be straight-chain or branched. It is preferably straight-chain and has 4 to 13 carbon atoms. Accordingly, it is in particular acryloyloxymethyl, 2-acryloyloxyethyl, 3-acryloyloxypropyl, 4-acryloyloxybutyl, 5-acryloyloxypentyl, 6-acryloyloxyhexyl, 7-acryloyloxyheptyl, 8-acryloyloxyoctyl, 9-acryloyloxynonyl, 10-acryloyloxydecyl, methacryloyloxymethyl, 2-methacryloyloxyethyl, 3-methacryloyloxypropyl, 4-methacryloyloxybutyl, 5-methacryloyloxypentyl, 6-methacryloyloxyhexyl, 7-methacryloyloxyheptyl, 8-methacryloyloxyoctyl or 9-methacryloyloxynonyl.

If one of the abovementioned radicals is an alkyl or alkenyl radical which is monosubstituted by CN or CF₃, this radical is preferably straight-chain. The substitution by CN or CF₃ is in any position.

If one of the abovementioned radicals is an alkyl or alkenyl radical which is at least monosubstituted by halogen, this radical is preferably straight-chain and halogen is preferably F or Cl. In the case of polysubstitution, halogen is preferably F. The resulting radicals also include perfluorinated radicals. In the case of monosubstitution, the fluoro or chloro substituent can be in any desired position, but is preferably in the c-position.

Compounds containing branched pendent groups may occasionally be of importance owing to better solubility in the conventional liquid-crystalline base materials. However, they are particularly suitable as chiral dopants if they are optically active.

Branched groups of this type generally contain not more than one chain branch. Preferred branched radicals are isopropyl, 2-butyl (=1-methylpropyl), isobutyl (=2-methylpropyl), 2-methylbutyl, isopentyl (=3-methylbutyl), 2-methylpentyl, 3-methylpentyl, 2-ethylhexyl, 2-propylpentyl, isopropoxy, 2-methylpropoxy, 2-methylbutoxy, 3-methylbutoxy, 2-methylpentoxy, 3-methylpentoxy, 2-ethylhexoxy, 1-methylhexoxy or 1-methylheptoxy.

If one of the abovementioned radicals is an alkyl radical in which two or more CH₂ groups have been replaced by —O— and/or —CO—O—, this can be straight-chain or branched. It is preferably branched arid has 3 to 12 carbon atoms. Accordingly, it is in particular biscarboxymethyl, 2,2-bis-carboxyethyl, 3,3-biscarboxypropyl, 4,4-biscarboxybutyl, 5,5-biscarboxypentyl, 6,6-biscarboxyhexyl, 7,7-biscarboxyheptyl, 8,8-biscarboxyoctyl, 9,9-biscarboxynonyl, 10,10-biscarboxydecyl, bis(methoxycarbonyl)methyl, 2,2-bis(methoxycarbonyl)ethyl, 3,3-bis(methoxycarbonyl)propyl, 4,4-bis-(methoxycarbonyl)butyl, 5,5-bis(methoxycarbonyl)pentyl, 6,6-bis(methoxycarbonyl)hexyl, 7,7-bis(methoxycarbonyl)heptyl, 8,8-bis(methoxycarbonyl)octyl, bis(ethoxycarbonyl)methyl, 2,2-bis(ethoxycarbonyl)ethyl, 3,3-bis-(ethoxycarbonyl)propyl, 4,4-bis(ethoxycarbonyl)butyl or 5,5-bis(ethoxycarbonyl)hexyl.

The invention furthermore relates to electro-optical displays containing LC media according to the invention, in particular SSCT and PSCT displays having two plane-parallel outer plates which, together with a frame, form a cell, and a cholesteric liquid-crystal mixture which is located in the cell.

The structure of bistable SSCT and PSCT cells is described, for example, in WO 92/19695, WO 93/23496, U.S. Pat. No. 5,453,863 or U.S. Pat. No. 5,493,430.

The invention furthermore relates to the use of the CLC media according to the invention for electro-optical purposes.

The liquid-crystal mixtures according to the invention allow a significant extension of the available parameter space. The achievable combinations of reflection wavelength, birefringence, clearing point, viscosity, thermal and UV stability and dielectric anisotropy are far superior to previous prior art materials and render the media according to the invention particularly suitable for use in CLC displays.

While maintaining the cholesteric phase down to −20° C., preferably down to −30° C., particularly preferably down to −40° C., the liquid-crystal mixtures according to the invention allow clearing points above 70° C., preferably above 90° C., particularly preferably above 1 10° C., simultaneously dielectric anisotropy values Δε≧5, preferably ≧10, birefringence values of between 0.15 and 0.3, preferably between 0.17 and 0.26, and low viscosity and resistivity values to be achieved, allowing excellent CLC displays to be achieved. In particular, the mixtures are characterized by low operating voltages.

It goes without saying that a suitable choice of the components of the mixtures according to the invention also allows higher clearing points (for example above 120° C.) to be achieved at the same time as higher threshold voltages, or lower clearing points to be achieved at the same time as lower threshold voltages while retaining the other advantageous properties. Likewise, mixtures of higher Δε and thus lower thresholds can be obtained at viscosities which are increased correspondingly little.

The cholesteric phase range is preferably ar least 90° C., in particular at least 100° C. This range preferably extends at least from −20° to +80° C.

The UV stability of the mixtures according to the invention is also considerably better, i.e. they exhibit a significantly smaller change in refelction wavelength and operating voltage on UV exposure.

The individual compounds of the following formulae and their subformulae which can be used in the media according to the invention are either known or can be prepared analogously to the known compounds.

In particularly preferred embodiments the mixtures comprise:

one or more compounds of the formulae Ia, Ib and/or Ie, in particular those in which L¹ and/or L² are F,

1 to 9, in particular 1 to 6, compounds of the formula I,

from 7% to 80%, in particular from 40% to 70% of one or more compounds of the formula I,

one or more compounds of the formula ha and/or lib, in particular those in which L¹, L² and L⁴ are H,

from 0% to 90%, in particular 0% to 70%, particularly preferably from 2 to 55%, of one or more compounds of the formula II,

from 5 to 40% of one or more compounds of the formula I and from 30 to 65% of one or more compounds of the formula II,

one or more compounds of the formula IIIa, IIIb and/or IIIe,

from 5% to 80%, in particular from 15% to 60%, of one or more compounds of the formula III,

one or more compounds of the formula IV25 and/or IV27 where L in formula IV 25 is H or F, particularly preferably F. The proportion of these compounds in the liquid-crystal mixtures is preferably from 0% to 50%, in particular from 5% to 15%,

one or more alkenyl compounds of the formula V1 and/or V2, preferably of the formulae V1e, V1f and V2a, in particular those in which R^{3a} is H. The proportion of these compounds in the liquid-crystal mixtures is preferably from 0% to 50%, in particular from 5% to 25%,

one or more compounds of the formula VI1 and/or VI2, preferably of the formulae VI1a and VI2b, in particular those in which R⁵ is alkyl or alkoxy having 1 to 8 carbon atoms. The proportion of these compounds in the liquid-crystal mixtures is preferably from 5% to 50%, in particular from 10% to 40%,

in total from 15 to 80% of compounds of the formulae II, III, IV, V1, V2, VI1 and VI2,

one or more dopants selected from the formulae VII, VIII and IX,

one or more dopants selected from the formulae X and XI,

one or more dopants selected from the formulae XII, XIII, XIV, XV and XVI,

not more than one dopant, preferably selected from the formulae XII, XIII, XIV, XV and XVI,

10% or less, in particular from 0.01 to 7%, of the optically active component,

a nematic component essentially consisting of compounds selected from the formulae I to VI2.

A suitable choice of the meanings of the terminal radicals R¹, R², R³, R⁴, R⁵, X⁰ and Q-Y in the compounds of the formulae I to VI2 allows the response times, the threshold voltage and other properties to be modified as desired. For example, 1E-alkenyl radicals, 3E-alkenyl radicals, 2E-alkenyloxy radicals and the like generally result in shorter response times, improved nematic tendencies and a higher ratio of the elastic constants K₃ (bend) and K₁ (splay) compared with alkyl or alkoxy radicals. 4-Alkenyl radicals, 3-alkenyl radicals and the like generally result in lower threshold voltages and smaller values of K₃/K₁ compared with alkyl and alkoxy radicals.

In the case of the bridging members Z¹, Z² and Z³, a —CH₂CH₂— group generally results in higher K₃/K₁ values compared to a single covalent bond. Higer K₃/K₁ values allow, for example, a shorter reflection wavelength without changing the dopant concentration owing to the higher HTP.

The optimum weight ratio of compounds of the formulae I to VI2 largely depends on the desired properties, on the choice of the components of the formulae I to VI2 and on the choice of any other components which may be present. Suitable weight ratios within the range given above can easily be determined from case to case.

The total amount of compounds of the formulae I to VI2 in the mixtures according to the invention is not critical. The mixtures can therefore comprise one or more further components in order to optimize various properties. However, the observed effect on the response times and the threshold voltage is usually greater the higher the total concentration of compounds of the formulae I to VI2.

The liquid-crystal mixtures which can be used in accordance with the invention are prepared in a manner conventional per se. In general, the desired amount of the components used in a lesser amount is dissolved in the components making up the principal constituent, expediently at elevated temperature. It is also possible to mix solutions of the components in an organic solvent, for example in acetone, chloroform or methanol, and to remove the solvent again after thorough mixing, for example by distillation.

The liquid-crystal mixtures according to the invention may also comprise further additives such as one or more stabilizers or antioxidants.

In the present application and in the following examples, the structures of the liquid-crystal compounds are specified by acronyms, which are transformed into chemical formulae according to the following Tables A and B. All radicals CₙH₂ₙ₊₁ and CₘH₂ₘ₊₁ are straight-chain alkyl radicals having n or m C atoms. The coding according to Table B is self-evident. Table A specifies the acronym for the parent body only. In individual cases, the acronym for the parent body is followed, separated therefrom by a hyphen, by a code for the substituents R¹, R², L¹, L² and L³:

| Code for | | | | | |
|---|---|---|---|---|---|
| R¹, R², | | | | | |
| L¹, L², L³ | R¹ | R² | L¹ | L² | L³ |
| nm | CₙH₂ₙ₊₁ | CₘH₂ₘ₊₁ | H | H | H |
| nOm | CₙH₂ₙ₊₁ | CₘH₂ₘ₊₁ | H | H | H |
| nO.m | CₙH₂ₙ₊₁ | OCₘH₂ₘ₊₁ | H | H | H |
| n | CₙH₂ₙ₊₁ | CN | H | H | H |
| nN.F | CₙH₂ₙ₊₁ | CN | H | H | F |
| nN.F.F | CₙH₂ₙ₊₁ | CN | H | F | F |
| nF | CₙH₂ₙ₊₁ | F | H | H | H |
| nOF | OCₙH₂ₙ₊₁ | F | H | H | H |
| nF.F | CₙH₂ₙ₊₁ | F | H | H | F |
| nmF | CₙH₂ₙ₊₁ | CₘH₂ₘ₊₁ | F | H | H |
| nOCF₃/nOT | CₙH₂ₙ₊₁ | OCF₃ | H | H | H |
| n-Vm | CₙH₂ₙ₊₁ | —CH═CH—CₘH₂ₘ₊₁ | H | H | H |
| nV-Vm | CₙH₂ₙ₊₁—CH═ | —CH═CH—CₘH₂ₘ₊₁ | H | H | H |
| | CH— | | | | |

Preferred mixture components are shown in Tables A, B and C.

TABLE A
(L¹, L², L³ = H or F)

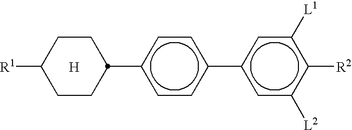

BCH

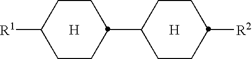

CCH

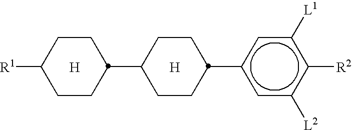

CCP

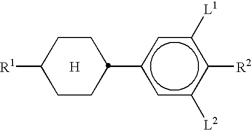

PCH

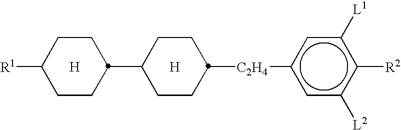

ECCP

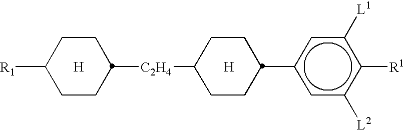

CECP

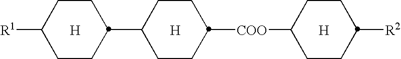

CH

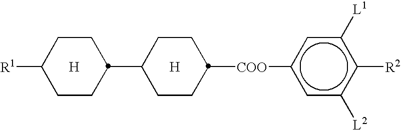

CP

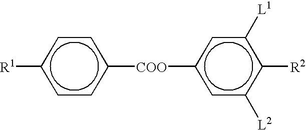

ME

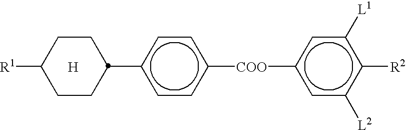

HP

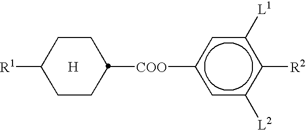

D

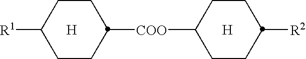

OS

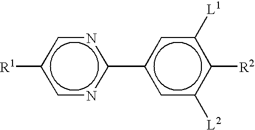

PYP

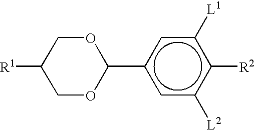

PDX

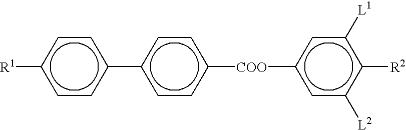

CE

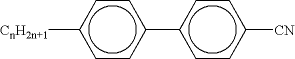

K3′n

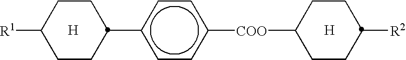

HD

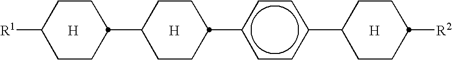

CCPC

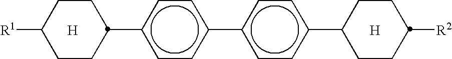

CBC

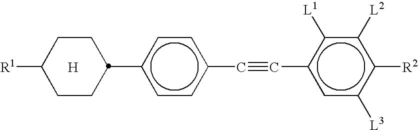

CPTP

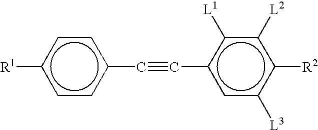

PTP

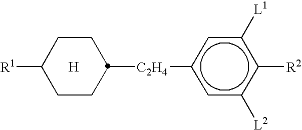

EPCH

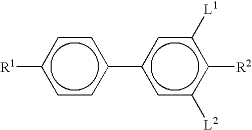

B

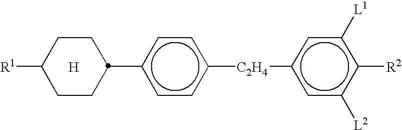

EBCH

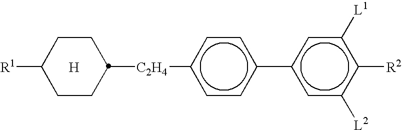

BECH

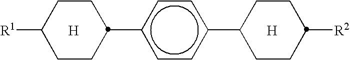

CPC

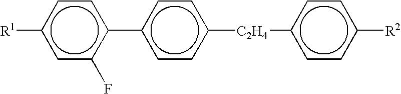

FET-nF

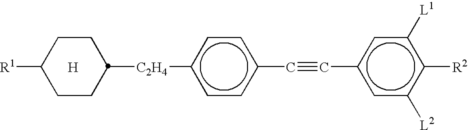

CEPTP

TABLE B

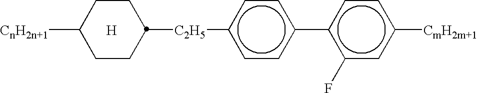

Inm

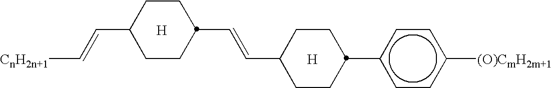

CVCP-nV-(O)m

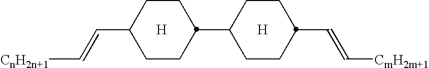

CC-nV-Vm

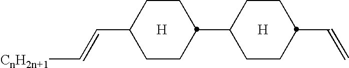

CC-n-V

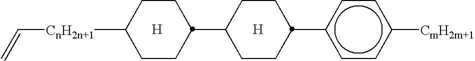

CCP-Vn-m

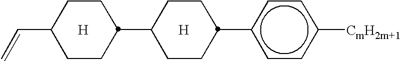

CCP-V-m

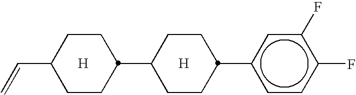

CCG-V-F

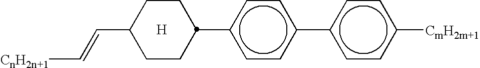

CPP-nV-m

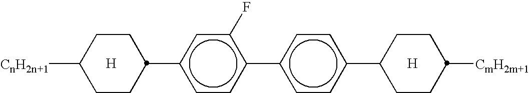

CBC-nmF

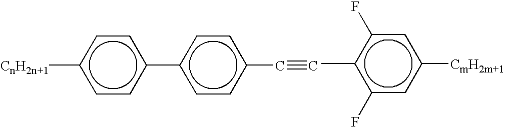

PPTUI-nm

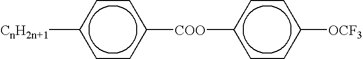

PZP-n-OT

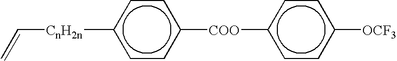

PZP-Vn-OT

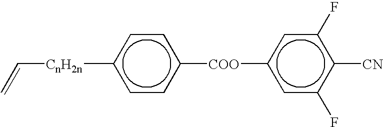

PZU-Vn-N

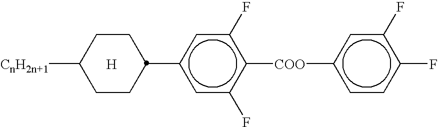

CUZG-n-F

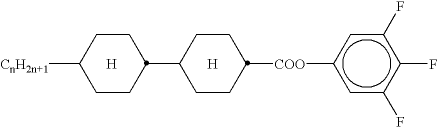

CCZU-n-F

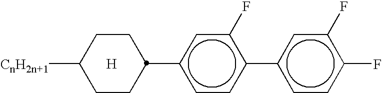

CGG-n-F

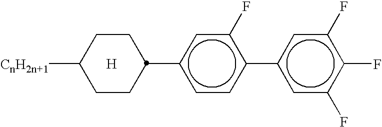

CGU-n-F

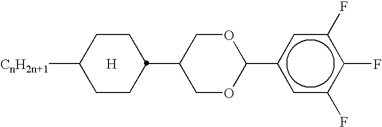

CDU-n-F

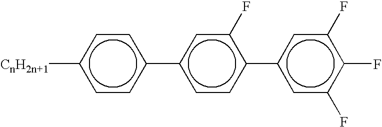

PGU-n-F

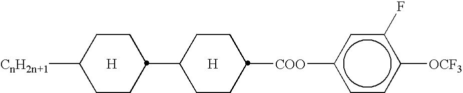

CCZG-n-OT

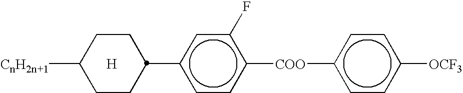

CGZP-n-OT

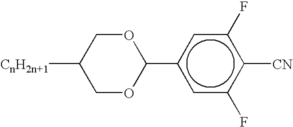

DU-n-N

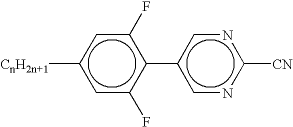

UM-n-N

TABLE C
(dopants):

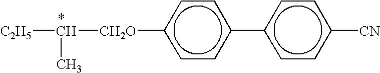

C 15

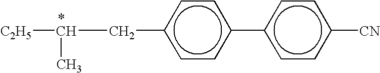

CB 15

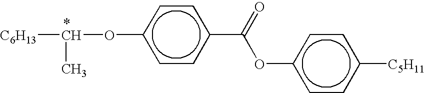

CM 21

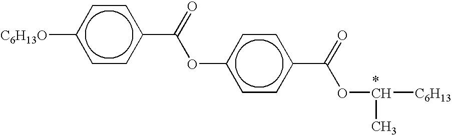

CM 33

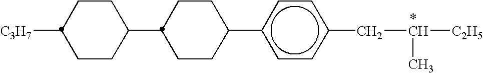

CM 44

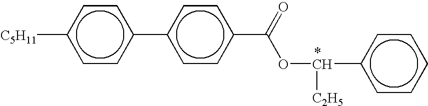

CM 45

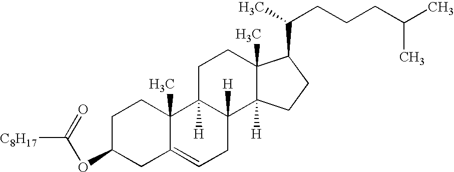

CN

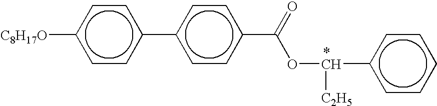

CM 47

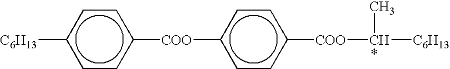

R/S 811

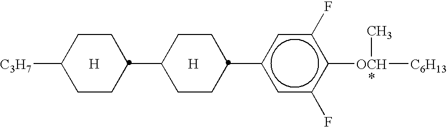

R/S 2011

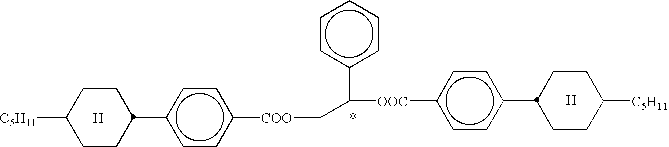

R/S 1011

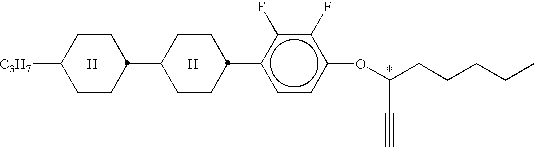

R/S 3011

TABLE D
Suitable stabilizers and antioxidants for liquid-crystalline mixtures are given
below (n = 0-10, terminal methyl groups are not shown):

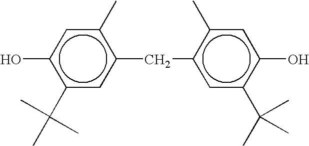

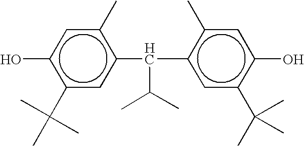

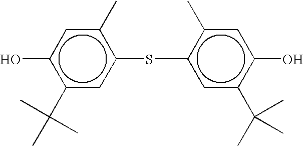

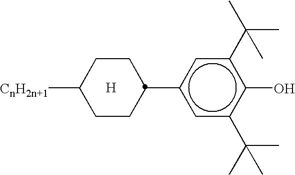

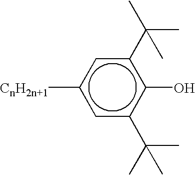

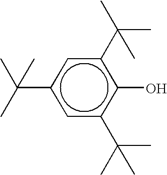

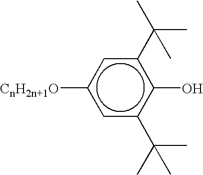

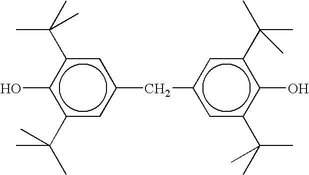

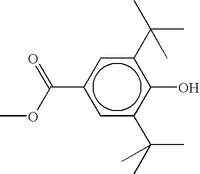

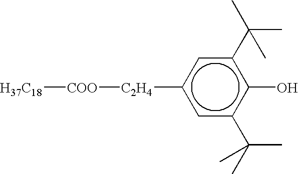

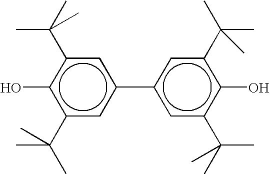

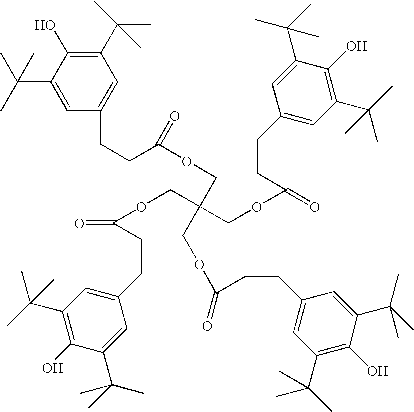

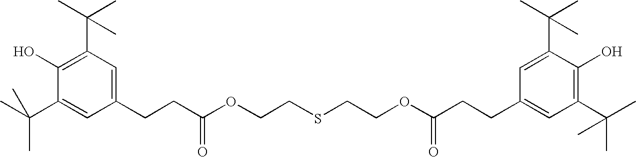

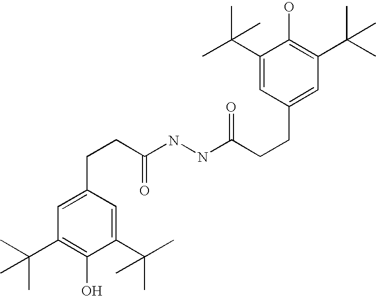

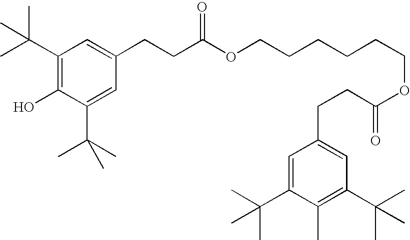

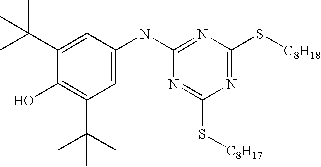

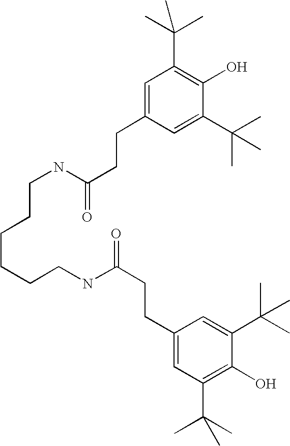

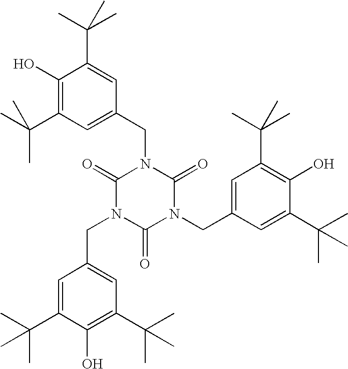

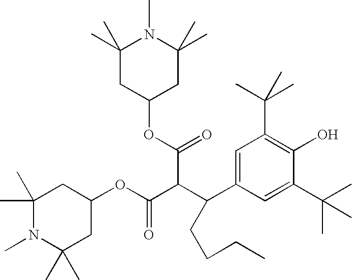

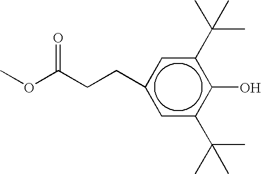

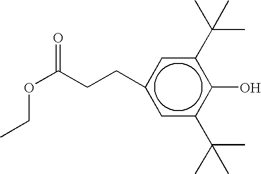

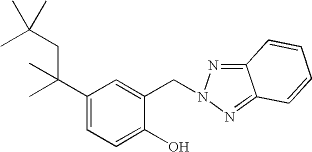

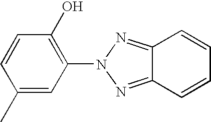

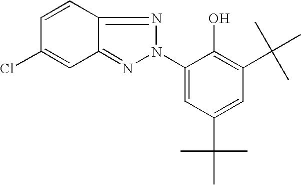

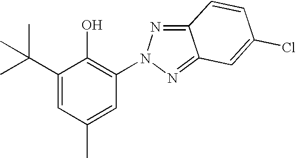

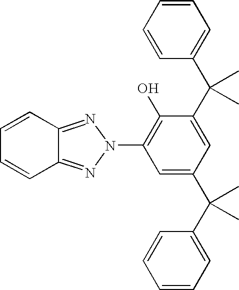

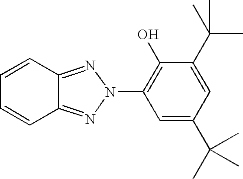

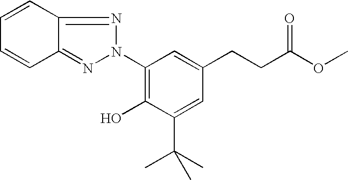

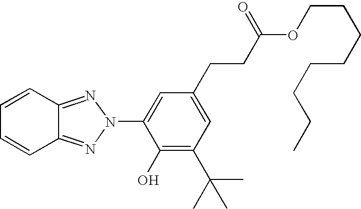

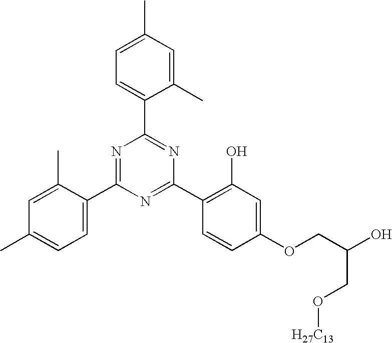

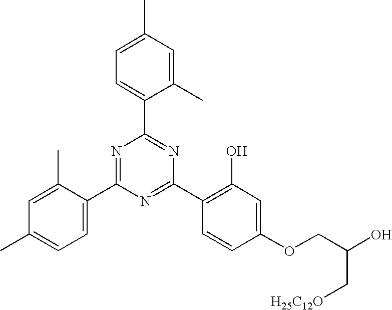

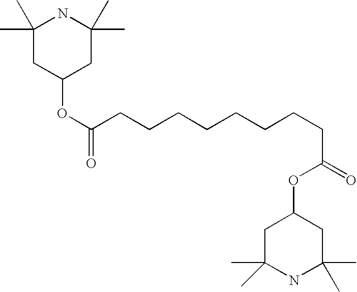

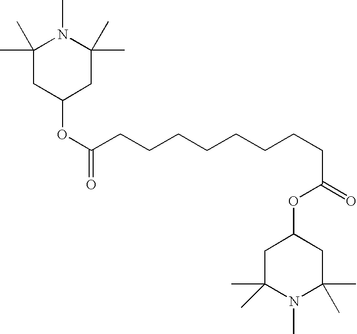

The following examples are intended to illustrate the invention without limiting it.

Hereinbefore and hereinafter, percentages are given in per cent by weight. All temperatures are specified in degrees Celsius. m.p. denotes melting point, cl.p.=clearing point. Furthermore, C=crystalline state, S=smectic phase, N=nematic phase, Ch=cholesteric phase and I=isotropic phase. The data between these symbols represent the transition temperatures.

Furthermore, the following abbreviations are used

Δn optical anisotropy at 589 nm and 20° C.

nₑ extraordinary refractive index at 589 nm and 20° C.

Δε dielectric anisotropy at 20° C.

ε∥ idielectric constant parallel to the longitudinal axes of the molecules

γ₁ rotational viscosity [mPa·sec] at 20° C. unless indicated otherwise

λ reflection wavelength [nm] at 20° C. unless indicated otherwise

Δλ maximum variation of the reflection wavelength [nm] in the given temperature range between −20 and +70° C. unless indicated otherwise

The helical twisting power HTP of a chiral compound which produces a helically twisted superstructure in a liquid-crystalline mixture is given by the equation HTP=(p·c)⁻¹ [μm⁻¹] in which p is the helical pitch of the helically twisted phase, given in μm, and c the concentration of the chiral compound (for example, a c value of 0.01 corresponds to a concentration of 1% by weight). Unless otherwise indicated, HTP values hereinbefore and hereinafter refer to a temperature of 20° C. and the commercially available neutral nematic TN host mixture MLC-6260 (Merck KGaA, Darmstadt).

### EXAMPLE 1

A cholesteric mixture comprises 94.52% of a nematic component A consisting of

| | | | |
|---|---|---|---|
| K6 | 8.0% | cl.p. | 98.4 |
| K9 | 9.0% | Δn | 0.1786 |
| ME3N.F | 10.0% | nₑ | 1.6836 |
| ME4N.F | 10.0% | Δε | +31.1 |
| BCH-5 | 10.0% | ε_{∥} | 38.3 |
| HP-3N.F | 7.0% | γ₁ | 373 |
| HP-4N.F | 5.0% | | |
| HP-5N.F | 5.0% | | |
| CBC-33 | 2.0% | | |
| CBC-33F | 3.0% | | |
| CBC-53 | 3.0% | | |
| CBC-55F | 3.0% | | |
| CC-5-V | 13.0% | | |
| ME2N.F | 8.0% | | |
| ME5N.F | 4.0% | | |

and 5.48% of a chiral compound of the formula

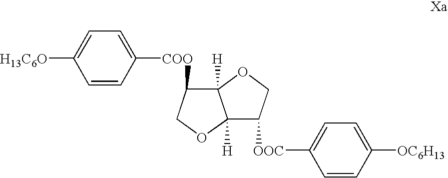

and has a λ of 499 nm and a Δλ of 77 nm.

### EXAMPLE 2

A cholesteric mixture comprises 96.26% of the nematic component A and 3.74% of a chiral compound of the formula

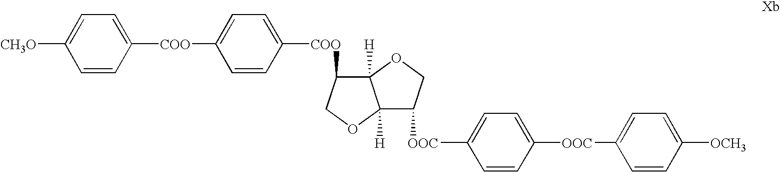

and has a λ of 545 nm and a Δλ of 9 nm.

### EXAMPLE 3

A cholesteric mixture comprises 94.05% of the nematic component A and 5.95% of a chiral compound of the formula

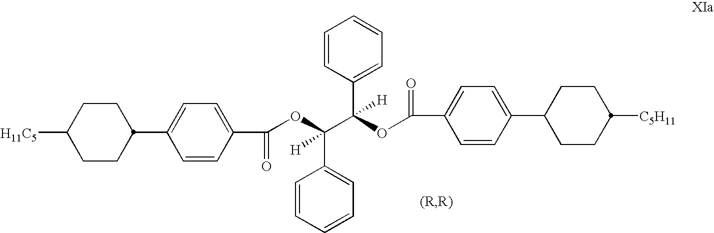

and has a λ of 512 nm and a Δλ of 84 nm.

### EXAMPLE 4

A cholesteric mixture comprises 94.04% of the nematic component A and 5.96% of a chiral compound of the formula

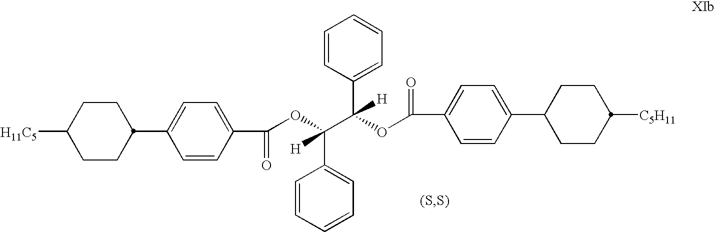

and has a λ of 512 nm and a Δλof 86 nm.

### EXAMPLE 5

A cholesteric mixture comprises 96% of the nematic component A and 4% of a chiral compound of the formula

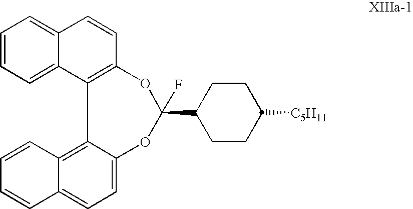

und has a λ of 479 nm and a Δλ of 29 nm.

### EXAMPLE 6

A cholesteric mixture comprises 96% of the nematic component A and 4% of a chiral compound of the formula

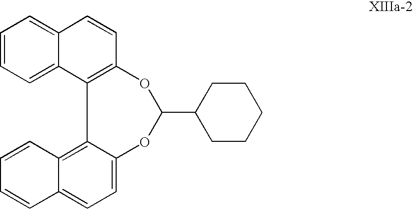

and has a λ of 494 nm and a Δλ of 85 nm.

### EXAMPLE 7

A cholesteric mixture comprises 96.6% of the nematic component A and 3.4% of a chiral compound of the formula

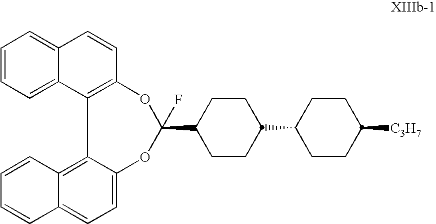

and has a λ of 506 nm and a Δλ of 13 nm.

### EXAMPLE 8

A cholesteric mixture comprises 97.24% of the nematic component A and 2.76% of a chiral compound of the formula

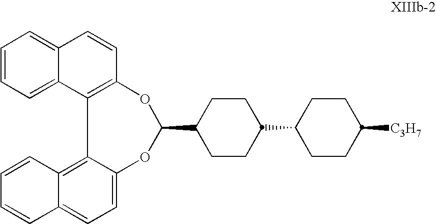

and has a λ of 536 nm and a Δλ of 25 nm.

### EXAMPLE 9

A cholesteric mixture comprises 95.88% of the nematic component A and 4.12% of a chiral compound of the formula

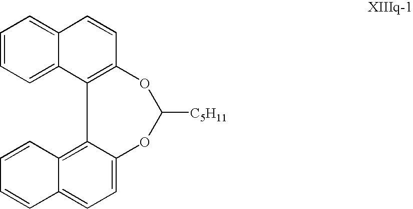

and has a λ of 509 nm and a Δλ of 63 nm.

### EXAMPLE 10

A cholesteric mixture comprises 96% of the nematic component A and 4% of a chiral compound of the formula

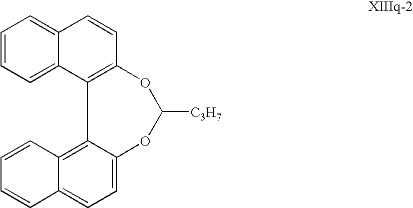

and has a λ of 507 nm and a Δλ of 63 nm.

### EXAMPLE 11

A cholesteric mixture comprises 96% of the nematic component A and 4% of a chiral compound of the formula

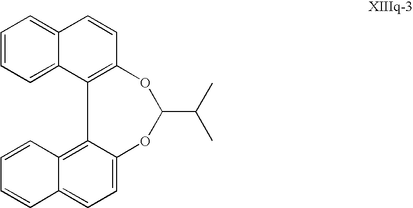

and has a λ of 575 nm and a Δλ of 97 nm.

### EXAMPLE 12

A cholesteric mixture comprises 97.5% of the nematic component A and 2.5% of a chiral compound of the formula

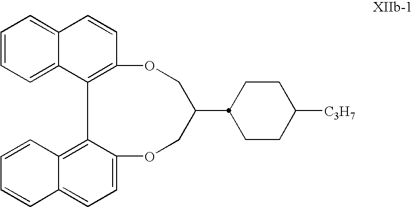

and has a λ of 518 nm and a Δλ of 31 nm.

### EXAMPLE 13

A cholesteric mixture comprises 96% of a nematic component B consisting of

| | | | |
|---|---|---|---|
| PCH-2 | 6.0% | cl.p. | 87.5 |
| PCH-3 | 18.0% | Δn | 0.2417 |
| ME2N.F | 2.0% | nₑ | 1.7552 |
| ME3N.F | 3.0% | Δε | +18.8 |
| ME4N.F | 8.0% | ε_{∥} | 24.3 |
| ME5N.F | 8.0% | γ₁ | 211 |
| PCH-302 | 4.0% | | |
| PPTUI-3-2 | 20.0% | | |
| PPTUI-3-4 | 31.0% | | |

and 4% of the chiral compound of the formula XIIIa-1 and has a λ of 544 nm and a Δλ of 22 nm.

### EXAMPLE 14

A cholesteric mixture comprises 96% of the nematic component B and 4% of the chiral compound of the formula XIIIa-2 and has a λ of 577 nm and a Δλ of 64 nm.

### EXAMPLE 15

A cholesteric mixture comprises 96.2% of the nematic component B and 3.8% of the chiral compound of the formula XIIIb-1 and has a λ of 520 nm and a Δλ of 38 nm.

### EXAMPLE 16

A cholesteric mixture comprises 97.01% of the nematic component B and 2.99% of the chiral compound of the formula XIIIb-2 and has a λ of 557 nm and a Δλ of 47 nm.

### EXAMPLE 17

A cholesteric mixture comprises 94.57% of the nematic component B and 5.43% of the chiral compound of the formula XIIIq-1 and has a λ of 470 nm and a Δλ of 48 nm.

### EXAMPLE 18

A cholesteric mixture comprises 97.5% of the nematic component B and 2.5% of the chiral compound of the formula XIIb-1 and has a λ of 613 nm and a Δλ of 22 nm.

### EXAMPLE 19

A cholesteric mixture comprises 95.9% of a nematic component C consisting of

| | | | |
|---|---|---|---|
| HP-3N.F | 5.0% | cl.p. | 113.0 |
| HP-4N.F | 5.0% | Δn | 0.2555 |
| ME2N.F | 7.0% | nₑ | 1.7676 |
| ME3N.F | 8.0% | Δε | +43.7 |
| ME4N.F | 12.0% | ε_{∥} | 50.6 |
| ME5N.F | 12.0% | | |
| PCH-302 | 2.0% | | |
| PPTUI-3-2 | 20.0% | | |
| PPTUI-3-4 | 24.0% | | |
| CCPC-33 | 3.0% | | |
| CCPC-34 | 2.0% | | |

and 4.1% of the chiral compound of the formula XIIIa-1 and has a λ of 527 nm and a Δλ of 29 nm.

### EXAMPLE 20

A cholesteric mixture comprises 96% of the nematic component C and 4% of the chiral compound of the formula XIIIa-2 and has a λ of 569 nm and a Δλ of 25 nm.

### EXAMPLE 21

A cholesteric mixture comprises 96.9% of the nematic component C and 3.1% of the chiral compound of the formula XIIIb-2 and has a λ of 547 nm and a Δλ of 78 nm.

### EXAMPLE 22

A cholesteric mixture comprises 95.15% of the nematic component C and 4.85% of the chiral compound of the formula XIIIq-1 and has λ of 523 nm and a Δλ of 11 nm.

### EXAMPLE 23

A cholesteric mixture comprises 97.5% of the nematic component C and 2.5% of the chiral compound of the formula XIIb-1 and has a λ of 526 nm and a Δλof 15 nm.

### EXAMPLE 24

A cholesteric mixture comprises 97.5% of a nematic component D consisting of

| | | | |
|---|---|---|---|
| K6 | 12.0% | cl.p. | 84.5 |
| K9 | 15.0% | Δn | 0.2095 |
| K12 | 19.0% | nₑ | 1.7335 |
| D-301 | 7.0% | Δε | +15.5 |
| T15 | 5.0% | ε_{∥} | 20.9 |
| BCH-5 | 15.0% | | |
| BCH-3F.F | 8.0% | | |
| BCH-5F.F | 7.0% | | |
| BCH-32 | 5.0% | | |

and 2.5% of a chiral compound of the formula XIIb-1 and has a λ of 566 nm and a Δλ of 21 nm.

1. Liquid-crystalline medium having a helically twisted structure and comprising a nematic component and an optically active component, characterized in that
the optically active component comprises one or more chiral compounds whose twisting power and concentration are selected such that the helical pitch of the medium is ≦1 μm, and
the nematic component comprises one or more compounds of the formula I 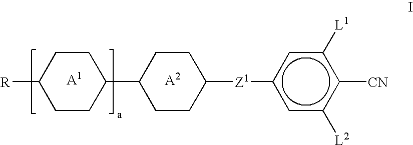
and one or more compounds selected from the formulae II and III 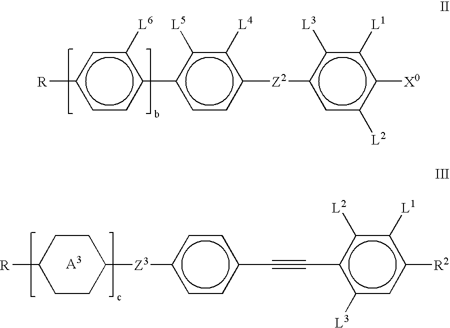
in which
R, R¹ and R² are each, independently of one another, H, an alkyl or alkenyl radical having 1 to 15 carbon atoms which is unsubstituted, monosubstituted by CN or CF₃ or at least monosubstituted by halogen, where one or more CH₂ groups in these radicals may also, in each case independently of one another, be replaced by —O—, —S—, — [symbol] —, —CO—, —CO—O—, —O—CO—, —O—CO—O— or —C≡C— in such a way that oxygen atoms are not linked directly to one another, 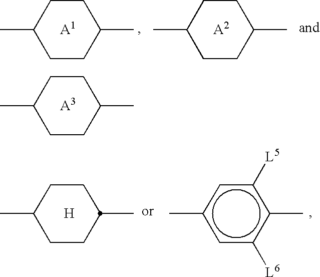
and are each, independently of one another,
L¹ to L⁶ are each, independently of one another, H or F,
Z¹ is —COO— and, if one of the radicals A¹ and A² is trans-1,4-cyclohexylene, furthermore —CH₂CH₂— or a single bond,
Z² is —CH₂CH₂— or a single bond,
Z³ is —COO—, —CH₂CH₂— or a single bond,
X is F, Cl, CN, halogenated alkyl, alkenyl or alkoxy having 1 to 6 carbon atoms, and
a, b and c are each, independently of one another, 0 or 1.

2. Medium according to claim 1, characterized in that it additionally comprises one or more compounds selected from the following formulae: 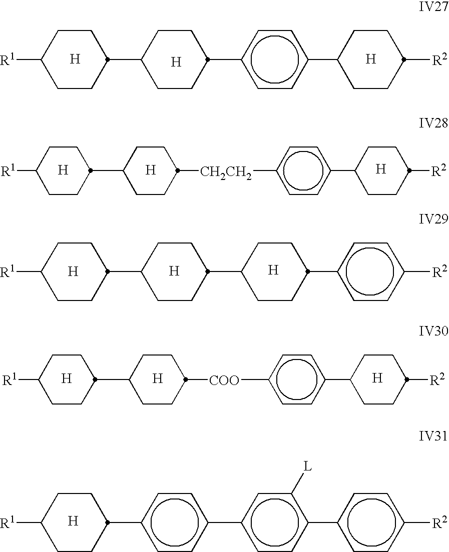
in which R¹ and R² are as defined in formula II and L is H or F.

3. Medium according to claim 1 or 2, characterized in it additionally comprises one or more alkenyl compounds selected from the following formulae: 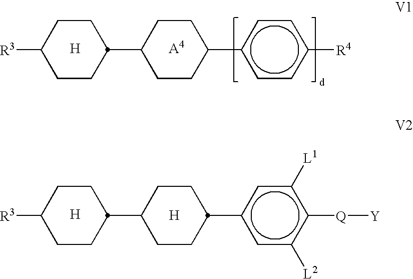
in which
A⁴ is 1,4-phenylene or trans-1,4-cyclohexylene,
d is 0 or 1,
R³ is an alkenyl group having 2 to 7 carbon atoms,
R⁴ is an alkyl, alkoxy or alkenyl group having 1 to 12 carbon atoms, where one or two non-adjacent CH₂ groups may also be replaced by —O—, —CH═CH—, —CO—, —OCO— or —COO— in such a way that oxygen atoms are not linked directly to one another,
Q is CF₂, OCF₂, CFH, OCFH or a single bond,
Y is F or Cl, and
L¹ and L² are each, independently of one another, H or F.

4. Medium according to at least one of claims 1 to 3, characterized in that it additionally comprises one or more compounds selected from the following formulae: 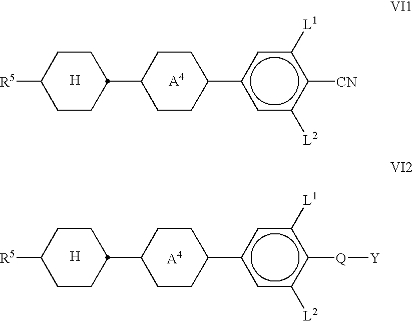
in which
A⁴ is 1,4-phenylene which also may be fluorinated in 3 and/or 5 position, or trans-1,4-cyclohexylene,
R⁵ is an alkyl, alkoxy or alkenyl group having 1 to 12 carbon atoms, where one or two non-adjacent CH₂ groups may also be replaced by —O—, —CH═CH—, —CO—, —OCO— or —COO— in such a way that oxygen atoms are not linked directly to one another,
Q is CF₂, OCF₂, CFH, OCFH or a single bond,
Y is F or Cl, and
L¹ and L² are each, independently of one another, H or F.

5. Medium according to at least one of claims 1 to 4, characterized in that the proportion of compounds of the formula I in the total mixture is from 7 to 80% by weight.

6. Medium according to at least one of claims 2 to 5, characterized in that the proportion of compounds of the formulae II to VI2 in the total mixture is from 15 to 80% by weight.

7. Medium according to at least one of claims 1 to 6, characterized in that the proportion of the optically active component is from 0.01 to 7%.

8. Medium according to at least one of claims 1 to 7, characterized in that it has a reflection wavelength in the range from 400 to 800 nm.

9. Use of the liquid-crystalline medium according to at least one of claims 1 to 8 for electro-optical purposes.

10. Electro-optical liquid-crystal display containing a liquid-crystalline medium according to at least one of claims 1 to 8.

11. Electro-optical liquid-crystal display according to claim 10, characterized in that it is a cholesteric or SSCT display.
